(19) United States
(12) Patent Application Publication
(10) Pub. No.: US 2016/0292921 A1
(43) Pub. Date: Oct. 6, 2016

(54) SYSTEM, APPARATUS, AND METHOD FOR DISPLAYING AN IMAGE USING LIGHT OF VARYING INTENSITIES

(71) Applicant: Avegant Corporation, Ann Arbor, MI (US)

(72) Inventors: Allan Thomas Evans, Redwood City, CA (US); Andrew Gross, Redwood City, CA (US)

(21) Appl. No.: 14/678,914

(22) Filed: Apr. 3, 2015

(51) Int. Cl. G06T 19/00; H04N 5/225; G02B 27/01; H04N 5/77; H04N 9/31; G06T 19/20; G06F 3/01

(52) U.S. Cl. CPC G06T 19/006; G06T 19/20; H04N 5/2252; G06F 3/013; H04N 5/77; H04N 9/317; H04N 9/3164; G02B 27/0172; G02B 2027/0118; G02B 2027/0138; G02B 2027/0145; G02B 27/14

(57) ABSTRACT

A system (100), apparatus (110), and method (900) for displaying an image (880). Light (800) of varying intensities (820) can be incorporated into the same image (880). Such an image (880) can be comprised of more than one subframe (852), and each subframe can correspond to a different intensity region (860) within the image (880) generated through a different pulse (810) of light (800).

### BACKGROUND OF THE INVENTION

The invention is a system, apparatus, and method for displaying an image (collectively, the “system”). More specifically, the system can use two or more light pulses of two or more intensities within a single image.

Prior art display technologies often provide viewers with images that are not realistic. This limitation can be true whether the image is a single stand-alone still frame image or part of a sequence of images comprising a video. The lack of realism can be particularly pronounced in the context of near-eye displays and 3D images.

In the real world, human beings can view a single scene that presents a static contrast ratio of 200,000 to 1, or even higher. In contrast, a clean print at a typical movie theater will have a contrast ratio of 500 to 1.

The human eye has a logarithmic sensitivity to light intensity, such that if light in one part of a person's field of view is 16× the intensity of light received in another area within the field of view, this will be perceived as being merely 4× times brighter, rather than 16× greater. This lack of sensitivity has some advantages in the real world, but in the context of display technologies that are already constrained in terms of contrast, the end result can be an undesirable lack of realism in displayed images. This lack of realism can be particularly pronounced in the context of near-eye displays and 3D images.

One of the reasons that display technologies suffer from relatively limited contrast ratios is that such technologies utilize light that does not vary in intensity. In the real world, light is constantly bouncing off different objects as well as coming in from the sky or internal light sources. The light used to comprise an artificially displayed image plays an important role in the contrast ratio of the image. Display technologies have spatial limitations and efficiency considerations that do not constrain light in the real world. Display technologies necessarily rely on light sources lacking in diversity, and the potential range of light intensity is correspondingly limited. Light from a particular light source operating at non-varying intensity with respect to a single image and traveling an identical path is necessarily going to be limited in terms of the range of intensities that can be represented. Whether such light can result in pixel values varying in intensity from 1 to 100, 1 to 500, or maybe even 1 to 1000, the end result is substantially tighter range of intensity values than what one would see in the real world.

Given the limitations on the range of light intensities that can displayed within a single image, the contrast in the display image is either (1) compressed to match the contrast range of the display or (2) clipped when it is outside the range of the display. The first approach preserves the detail of the scene, but the altered contrast can make the image appear less realistic. The second approach preserves the contrast of the scene for areas of between the maximum and minimum intensity range of the display. But it results in a loss of detail in the areas of the image that are either brighter or dimmer than the thresholds of the display. Neither approach is particularly satisfying the viewer.

It would be desirable for a display system to display realistic images that are neither compressed nor clipped, or at least involved less compression or less clipping. It would be desirable for light of varying intensities to be used within an image to increase the static contrast ratio within that image.

### SUMMARY OF THE INVENTION

The invention is system, apparatus, and method for displaying an image (collectively, the “system”). More specifically, the system uses two or more light pulses of two or more different intensities to create an image.

The system can illuminate different subframes within an image using different light pulses with different intensities of light. Different embodiments of the system can utilize a different number of light pulses with a different light intensities in the same image. Some embodiments of the system can involve two light pulses of two different intensities used to create to two different intensity regions within the displayed image. Other embodiments can involve three intensity regions, or even more than three intensity regions.

The system can factor in a variety of different variables in dividing up an image into different intensity regions corresponding to different pulse intensities and contrast ranges. One approach is to divide an image into different intensity regions based solely on the media content. Other factors such as eye tracking and/or ambient light can also be used to impact how the intensity regions within the image are identified and implemented.

### BRIEF DESCRIPTION OF THE DRAWINGS

Many features and inventive aspects of the system are illustrated in various drawings described briefly below. All components illustrated in the drawings below and associated with element numbers are named and described in Table 1 provided in the Detailed Description section.

FIG. 1A is a block diagram illustrating an example of a prior art display system in which a light source generates a light pulse that is modulated into an image. The light pulse is of a single light intensity, and the image is comprised of pixels within an intensity range.

FIG. 1B is an input-output diagram illustrating an example of the resulting intensity range being determined by the intensity of the light reaching the modulator.

FIG. 1C is a block diagram illustrating an example of the system. In contrast to FIG. 1A, the system involves multiple light pulses of different intensities being used to modulate an image comprised of different subframes possessing different intensity ranges corresponding to the different light pulses.

FIG. 1D is an input-output diagram illustrating an example of the resulting expanded intensity range being determined by the intensity of the light reaching the modulator. The expanded intensity range of FIG. 1D is double the range of FIG. 1B.

FIG. 1E is a diagram illustrating an example of an image comprised of pixels.

FIG. 1F is a prior art diagram illustrating an example of a pixel possessing an intensity value from within an intensity range.

FIG. 1G is diagram illustrating an example of a pixel possessing an intensity value within an expanded intensity range that includes two intensity ranges of light. The expanded intensity range of FIG. 1G is double that of the prior art illustration in FIG. 1F.

FIG. 1H is a prior art diagram illustrating an example of an image in which all areas of the image are part of the same intensity region.

FIG. 1I is a diagram illustrating an example of an image in which unlike the image of FIG. 1H, different areas of the image are part of different intensity regions.

FIG. 1J is a hierarchy diagram illustrating an example of a video comprised of multiple frames, and in which at least one frame is comprised of multiple subframes corresponding to different intensity regions.

FIG. 1K is a flow chart diagram illustrating an example of a method for using more than one light pulse and more than light intensity to create the image.

FIG. 1L is an input-output diagram in which intensity regions are determined solely by the media content being displayed.

FIG. 1M is an input-output diagram in which intensity regions are determined by a combination of two factors, the media content being displayed and the exterior environment in which the image is being displayed or viewed.

FIG. 1N is an input-output diagram in which intensity regions are determined by a combination of two factors, the media content being displayed and an eye tracking attribute pertaining to the viewer's interaction with the displayed image.

FIG. 1O is an input-output diagram in which intensity regions are determined by a combination of three factors, the media content being displayed, the lighting conditions of the exterior environment, and an eye tracking attribute pertaining to the viewer's interaction with the displayed image.

FIG. 2A is a block diagram illustrating an example of a light source in an illumination assembly supplying light to a modulator in an imaging assembly that is used to generate an image that can be accessed by the user.

FIG. 2B is a block diagram illustrating an example of a light source in an illumination assembly supplying light to a modulator in an imaging assembly that creates an interim image from the supplied light. The interim image can be modified and/or directed by the projection assembly into a final version of the image that is made accessible to the user through a display.

FIG. 2C is a block diagram illustrating an embodiment of the system similar to the system illustrated in FIG. 2B, except that the projection assembly includes a configuration of a curved mirror and a splitting plate to facilitate the ability of a sensor assembly to capture information from the user while simultaneously delivering an image to the user.

FIG. 2D is a hierarchy diagram illustrating an example of different components that can be included in an illumination assembly.

FIG. 2E is a hierarchy diagram illustrating an example of different components that can be included in an imaging assembly.

FIG. 2F is a hierarchy diagram illustrating an example of different components that can be included in a projection assembly.

FIG. 2G is a hierarchy diagram illustrating an example of different components that can be included in a sensor assembly.

FIG. 2H is a block diagram illustrating examples of different types of supporting components that can be included in the structure and function of the system.

FIG. 2I is a flow chart diagram illustrating an example of a method for displaying an image.

FIG. 3A is a block diagram illustrating an example of a DLP system.

FIG. 3B is a block diagram illustrating an example of a DLP system.

FIG. 3C is a block diagram illustrating an example of a LCOS system.

FIG. 3D is block diagram illustrating an example of a system with a projection assembly that includes a curved mirror and splitter plate.

FIG. 4A is diagram of a perspective view of a VRD apparatus embodiment of the system.

FIG. 4B is environmental diagram illustrating an example of a side view of a user wearing a VRD apparatus embodying the system.

FIG. 4C is a configuration diagram illustrating an example of the components that can be used in a VRD apparatus embodiment of the system.

FIG. 4D is a configuration diagram illustrating an example of the components that can be used in a VRD apparatus embodiment of the system that includes a curved mirror and a splitter plate.

FIG. 5A is a hierarchy diagram illustrating an example of the different categories of display systems that the innovative system can be potentially be implemented in, ranging from giant systems such as stadium scoreboards to VRD visor systems that project visual images directly on the retina of an individual user.

FIG. 5B is a hierarchy diagram illustrating an example of different categories of display apparatuses that closely mirrors the systems of FIG. 5A.

FIG. 5C is a perspective view diagram illustrating an example of user wearing a VRD visor apparatus.

FIG. 5D is hierarchy diagram illustrating an example of different display/projection technologies that can be incorporated into the system, such as DLP-based applications.

FIG. 5E is a hierarchy diagram illustrating an example of different operating modes of the system pertaining to immersion and augmentation.

FIG. 5F is a hierarchy diagram illustrating an example of different operating modes of the system pertaining to the use of sensors to detect attributes of the user and/or the user's use of the system.

FIG. 5G is a hierarchy diagram illustrating an example of different categories of system implementation based on whether or not the device(s) are integrated with media player components.

FIG. 5H is hierarchy diagram illustrating an example of two roles or types of users, a viewer of an image and an operator of the system.

FIG. 5I is a hierarchy diagram illustrating an example of different attributes that can be associated with media content.

FIG. 5J is a hierarchy diagram illustrating examples of different contexts of images.

### DETAILED DESCRIPTION

The invention is a system, apparatus, and method for displaying an image (collectively, the “system”). More specifically, the system can use two or more light pulses of two or more intensities within a single image.

### I. OVERVIEW

In the real world, the range in light brightness from dark to bright is substantial. Human beings can view a single scene that presents a static contrast ratio of 200,000 to 1, or even higher. In contrast, a clean print at a typical movie theater will have a contrast ratio of 500 to 1.

One of the reasons that display technologies suffer from relatively limited contrast ratios is that such technologies utilize light that does not vary in intensity within the image. In the real world, light is constantly bouncing off different objects as well as coming in from the sky or internal light sources. In an artificially created image generated by an image display device, the light used to comprise an artificially displayed image plays an important role in the contrast ratio of the image. Bright light can be used to support a bright image and dimmer light can be used to support a dimmer image, but if a scene includes both very bright areas and very dark or dim areas, use of a single light source for that image will not result in a satisfactory image. Moreover, display technologies have spatial limitations and efficiency considerations that do not constrain light in the real world. Display technologies necessarily rely on light sources lacking in diversity, and the potential range of light intensity is correspondingly limited. Light from a particular light source operating at non-varying intensity with respect to a single image and traveling an identical path is necessarily going to be limited in terms of the range of intensities that can be represented. Whether such light can result in pixel values varying in intensity from 1 to 100, 1 to 500, or maybe even 1 to 1000, the end result is substantially tighter range (i.e. substantially more narrow) of intensity values than what one would see in the real world.

The system can employ multiple light sources with different intensities to generate images with high dynamic range. Instead of projecting the entire frame at one time, bright areas of the frame are projected in one subframe using a high intensity sources, while darker areas are project in a second subframe, using a less intense light source. Additional subdivision of the image can be achieved using light sources. The system can then project each subframe sequentially to create a composite image with a dynamic range of several orders of magnitude, and high contrast resolution across the entire range of the intensities being projected.

The system can be used with transparent displays as well as without transparent displays. In the case of use with a transparent display, the system includes the use of one or more images sensors to track the position of the users pupils, and an ambient light sensor, which may also be camera facing away from the user. The information from the ambient light sensor and eye-tracking system are used to adjust the brightness of the projected image in real time, based both on the overall brightness of the real-world background image, but also where within their field of view, the user's gaze is directed.

The system allows the projection of more realistic images using near eye displays compared to current. The human eye has a logarithmic sensitivity to light intensity, i.e. if light in one part of a person's field of view is 16× the intensity of light received in another area of your field of view, this will be perceived as being 4× times brighter, rather than 16× greater. Real world scenes can present contrast ratios of 200,000:1 or higher. However, current near-eye display technologies and other display technologies are not able to reproduce images with contrast ratios equivalent to those found in the real world. Instead, the contrast of the image is compressed to match the contrast range of the display, or the intensity is clipped when it is outside the range of the display. The first approach preserves the detail of the scene, but the altered contrast can make the image appear less realistic. The second approach preserves the contrast of the scene for areas of between the maximum and minimum intensity range of the display. But it results in a loss of detail in the areas of the image that are either brighter or dimmer than the thresholds of the display.

When used with a transparent display, the system can provide the advantage of being able to provide a consistent contrast ratio between the projected image and the real-world background image. The use of multiple light sources can be key to matching the ambient illumination levels both in a dim interior setting, and in a bright outdoor setting, while maintaining a high contrast resolution. The ambient light sensor in the system is used to assign the maximum brightness need for projecting the image. In the case that the ambient light sensor is a camera, the system is able subdivide the frame into subframes/intensity regions to use different illumination level based both on the contrast of the projected image and the local brightness of the background image. The system can provide further refinement of the image contrast by using the eye-tracking information to enhance the contrast resolution in the area of the image that the users is focusing on.

The brightness of the higher power module determines the maximum intensity of light in the projected image. The second source has an intensity that is a fraction of the first light source. The pixels in an image frame with light intensities above that provided by the low intensity module source would be projected in one subframe, illuminated by the first (high-intensity) light source. The pixels with intensities less than the light intensity of the second source would be projected in a second sub-frame, illuminated by the low intensity source. The two subframes/intensity regions can be project in either order. The concept can be extrapolated to use an arbitrary number of light sources, with exponentially varying intensities. As an example light source 2 would have 10% the intensity of light source 1, and light source 3 would have 10% percent the intensity of light source 2. The ratio used may vary based on the specific implementation.

The system can incorporate eye-tracking to determine where in the projected frame the user is looking. The selection of the light sources can be adjusted accordingly.

In the case that the focusing mirror is partially reflective, the system also includes an ambient light intensity detector. The data from the ambient light sensor is used to select a light source so that the projected images have the correct brightness relative to the background image that is transmitted through the partially reflective mirror. In the case that the ambient light sensor is also a forward facing image sensor, the contrast of the projected image can be further refined by overlaying the position of the project image with the captured image, and adjusting the projected light based on the local background brightness and contrast.

A. Prior Art—Low Contrast

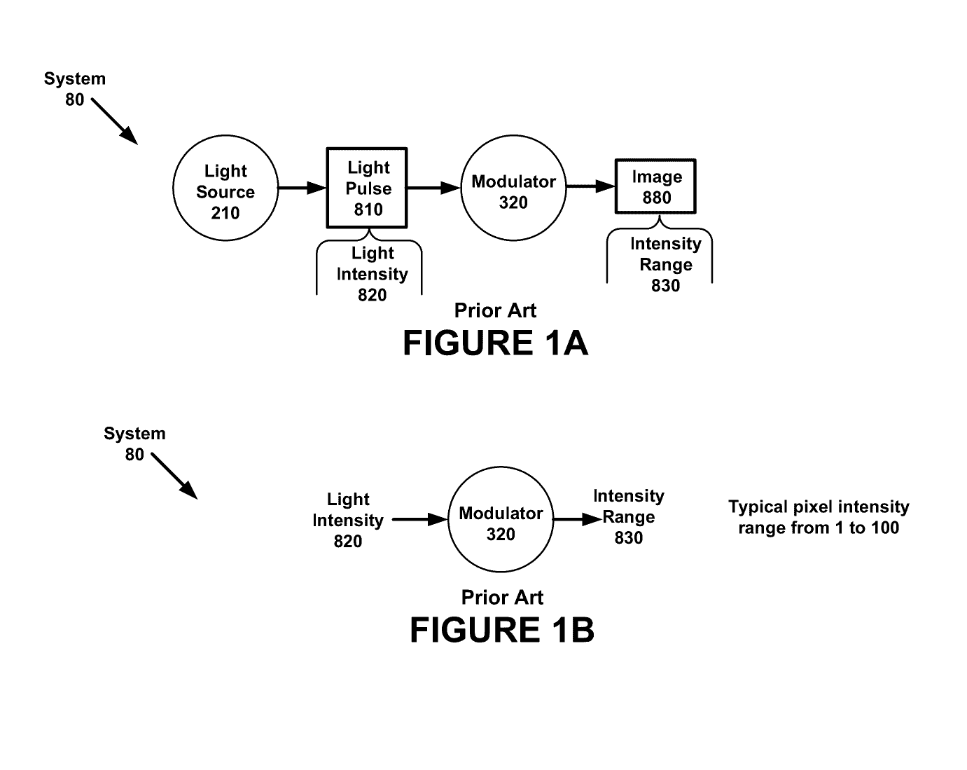

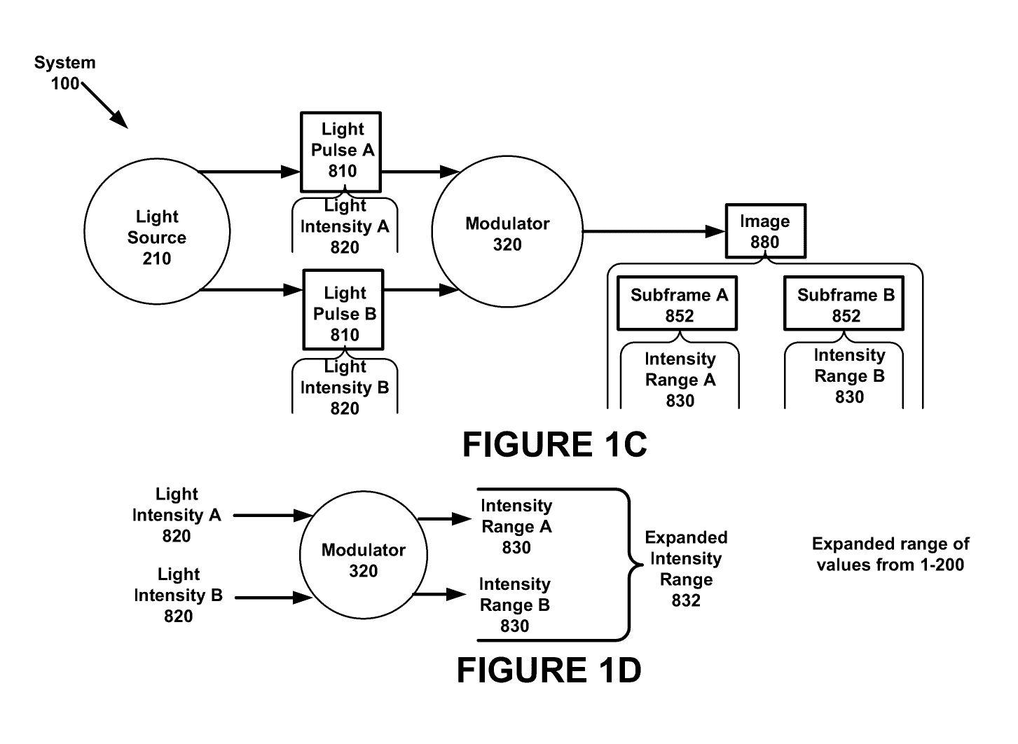

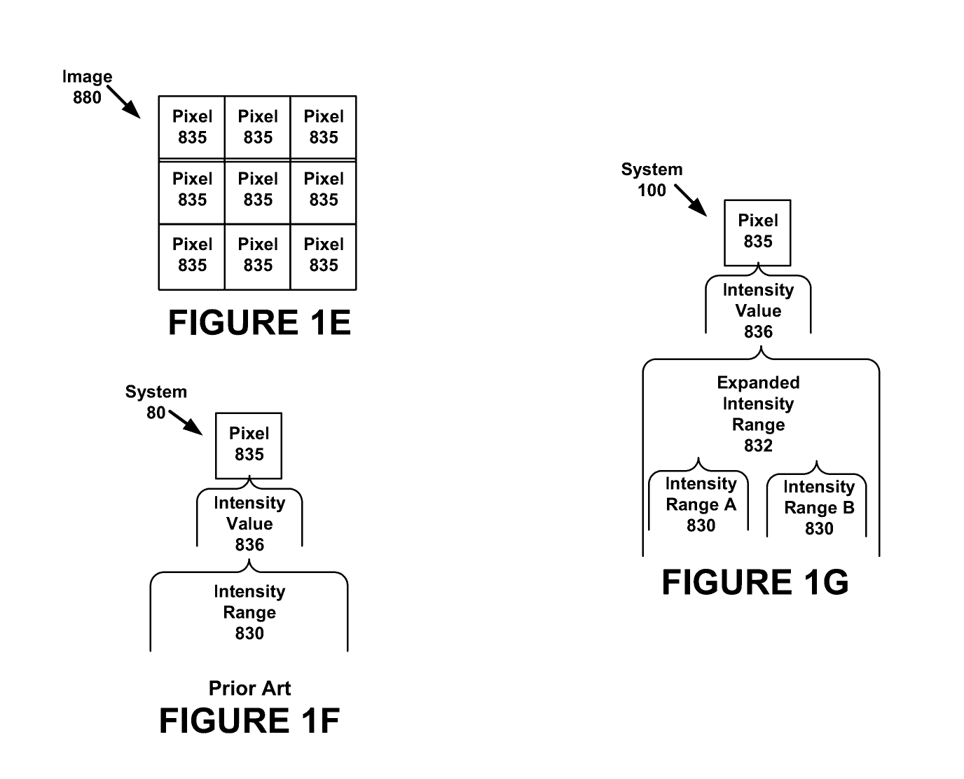

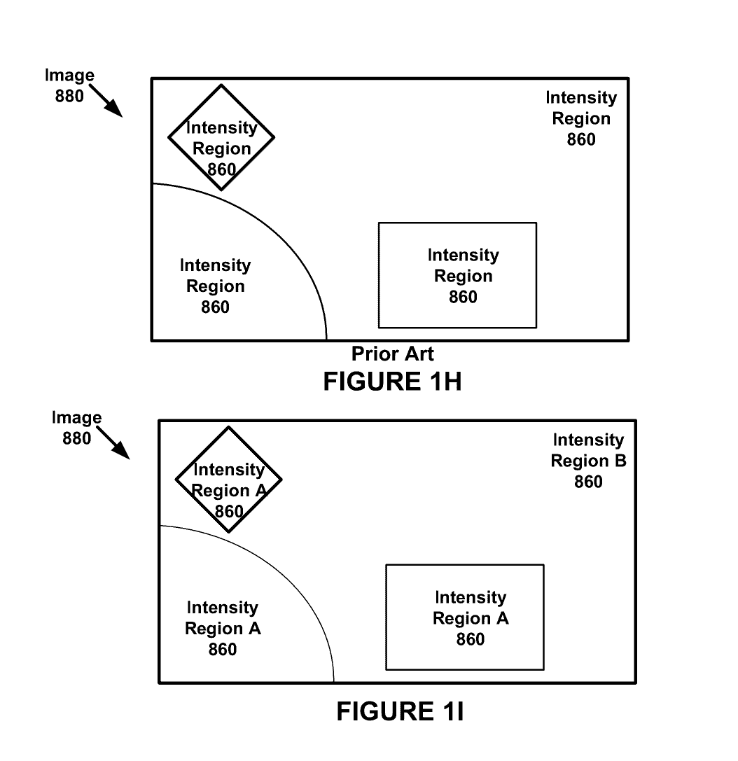

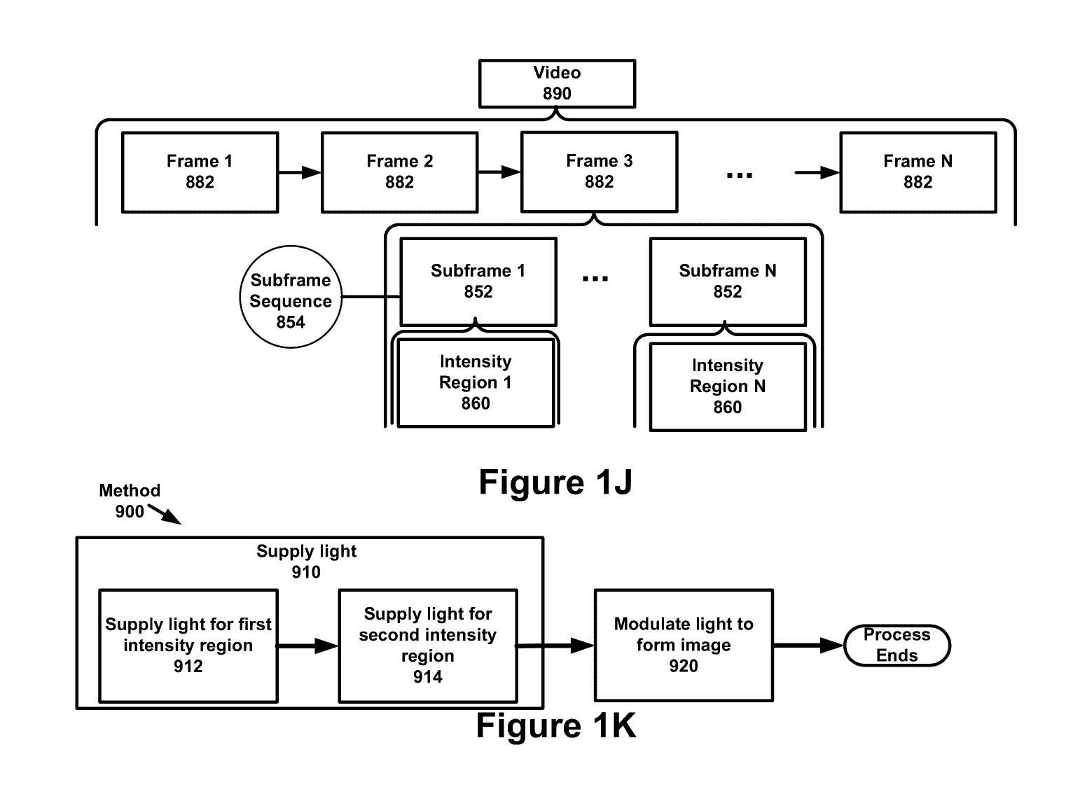

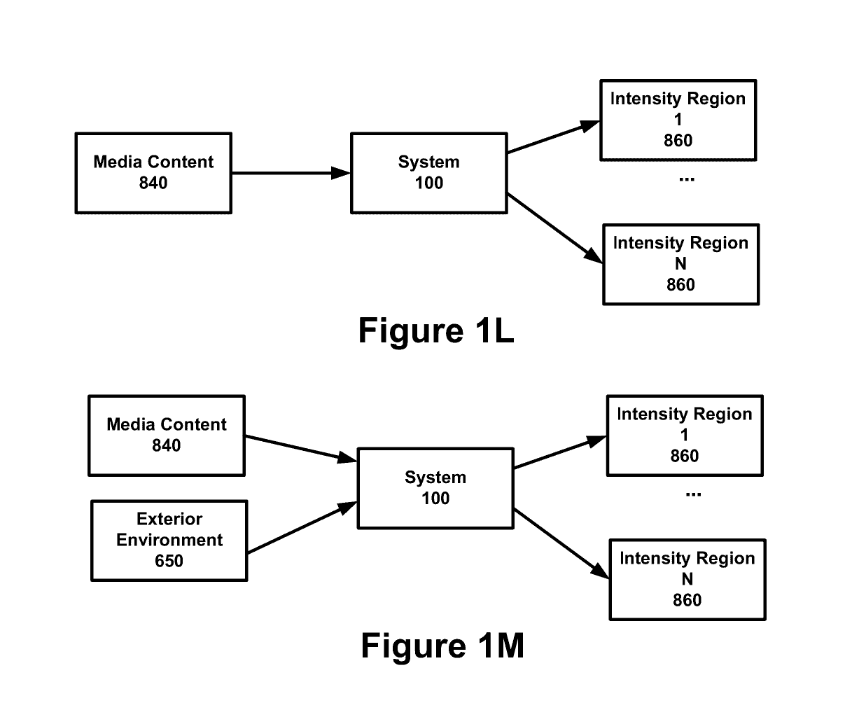

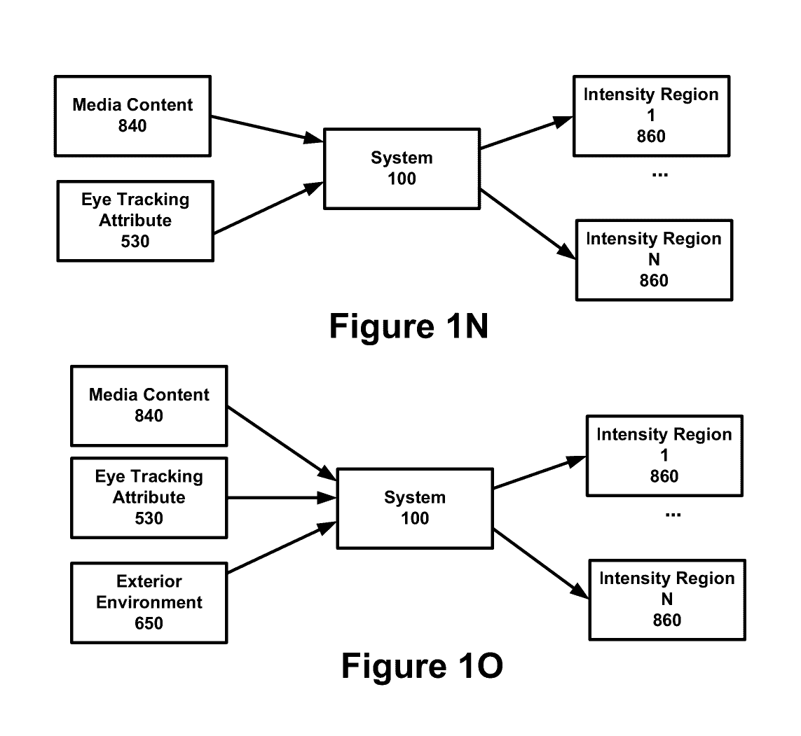

FIG. 1A is a block diagram illustrating an example of a prior art display system 80 in which a light source 210 generates a light pulse 810 that is modulated into an image 880. The light pulse 810 is of a single light intensity 820, and the image 880 is comprised of pixels within an intensity range 830. The intensity range 830 for the image 880 is limited because it the light used to make the image 880 originates from a single source.

FIG. 1B is an input-output diagram illustrating an example of the resulting intensity range 830 being determined by the intensity of the light 800 reaching the modulator 320.

B. System—Expanded Intensity Range

FIG. 1C is a block diagram illustrating an example of a system 100 with an expanded intensity range 832. In contrast to FIG. 1A, the system 100 involves multiple light pulses 810 of different intensities 820 being used to modulate an image 880 comprised of different subframes 852 possessing different intensity ranges corresponding to the different light pulses 810. The different pulse 810 can apply different intensity light 800 for purposes of enhancing the intensity range 820. Different pulses 810 can be used to apply different intensity light 800 of the same color. The purpose of such pulses 810 is to enhance the range of intensities 820 in an image, not to enhance the mixture of colors.

FIG. 1D is an input-output diagram illustrating an example of the resulting expanded intensity range 832 being determined by the intensity 820 of the light 800 reaching the modulator 320. The expanded intensity range 832 of FIG. 1D is double the range of FIG. 1B.

FIG. 1E is a diagram illustrating an example of an image 880 comprised of pixels 835. The system 100 allows different pixels 835 to be illuminated through the use of different light sources 210 of different intensities 820.

C. Pixels—Expanded Intensity Range

FIG. 1F is a prior art diagram illustrating an example of a pixel 835 possessing an intensity value 836 from within an intensity range 830.

FIG. 1G is diagram illustrating an example of a pixel 835 possessing an intensity value 836 within an expanded intensity range 832 that includes two intensity ranges 830 of light. The expanded intensity range 832 of FIG. 1G is double that of the prior art illustration in FIG. 1F. By breaking an image 880 into subframes 852 comprising intensity regions 860 within the image 880, the system 100 can utilize different light sources 210 of different intensities 820 to expand the aggregate range of intensity values that are possible within any given image 880.

D. Intensity Regions within the Image

FIG. 1H is a prior art diagram illustrating an example of an image 880 in which all areas of the image 880 are part of the same intensity region 860.

FIG. 1I is a diagram illustrating an example of an image 880 in which unlike the image of FIG. 1H, different areas of the image 880 are part of different intensity regions 860. Different intensity regions 860 can be illuminated using different pulses 810 of light with different intensities 820.

E. Subframes

FIG. 1J is a hierarchy diagram illustrating an example of a video comprised of multiple frames 882, and in which at least one frame 882 is comprised of multiple subframes 852 corresponding to different intensity regions 860. Subframes 852 are illuminated in accordance with a subframe sequence 854. Subframe sequences 854 can determine the order of the subfarme pulses 810, the duration of those pulses 810, and the intensity 820 of the pulses 810.

Breaking down an image 880 into subframes 852 facilitates the use of different light pulses 810 in the same image 880. Subframes 852 are illuminated quickly, so that the viewer 96 cannot perceive that an image 880 is being broken down into subimages. A similar concept underlies the use of video 890, which consists of still images 882 that are displayed quickly in succession.

F. Process Flow View

FIG. 1K is a flow chart diagram illustrating an example of a method 900 for using more than one light pulse and more than light intensity to create the image.

At 910, light is supplied for the image 880. This step can be broken down into two substeps. At 912 a pulse 810 of light 800 is supplied for a first intensity region 860. At 914, a pulse 810 of light 800 is supplied for a second intensity region 860.

At the 920, each pulse 810 of light 800 is modulated by the modulator 320 into an image 880 (or at least an interim image 850).

G. Factors that can Impact the Defining of Intensity Regions

The system 100 can defined intensity regions 860 using different input factors to selectively influence how many intensity regions 860 are included, and how pixels 835 are divided into different intensity regions 860.

1. Media Content as the Sole Factor

FIG. 1L is an input-output diagram in which intensity regions 860 are determined solely by the media content 840 being displayed.

2. Media Content+Ambient Lighting

FIG. 1M is an input-output diagram in which intensity regions 860 are determined by a combination of two factors, the media content 840 being displayed and the exterior environment 650 in which the image 880 is being displayed or viewed.

3. Media Content+Eye Tracking

FIG. 1N is an input-output diagram in which intensity regions 460 are determined by a combination of two factors, the media content 840 being displayed and an eye tracking attribute 530 pertaining to the viewer's interaction with the displayed image 880.

4. Media Content+Ambient Lighting+Eye Tracking

FIG. 1O is an input-output diagram in which intensity regions 860 are determined by a combination of three factors, the media content 840 being displayed, the lighting conditions of the exterior environment 650, and an eye tracking attribute 530 pertaining to the viewer's interaction with the displayed image 880.

### II. ASSEMBLIES AND COMPONENTS

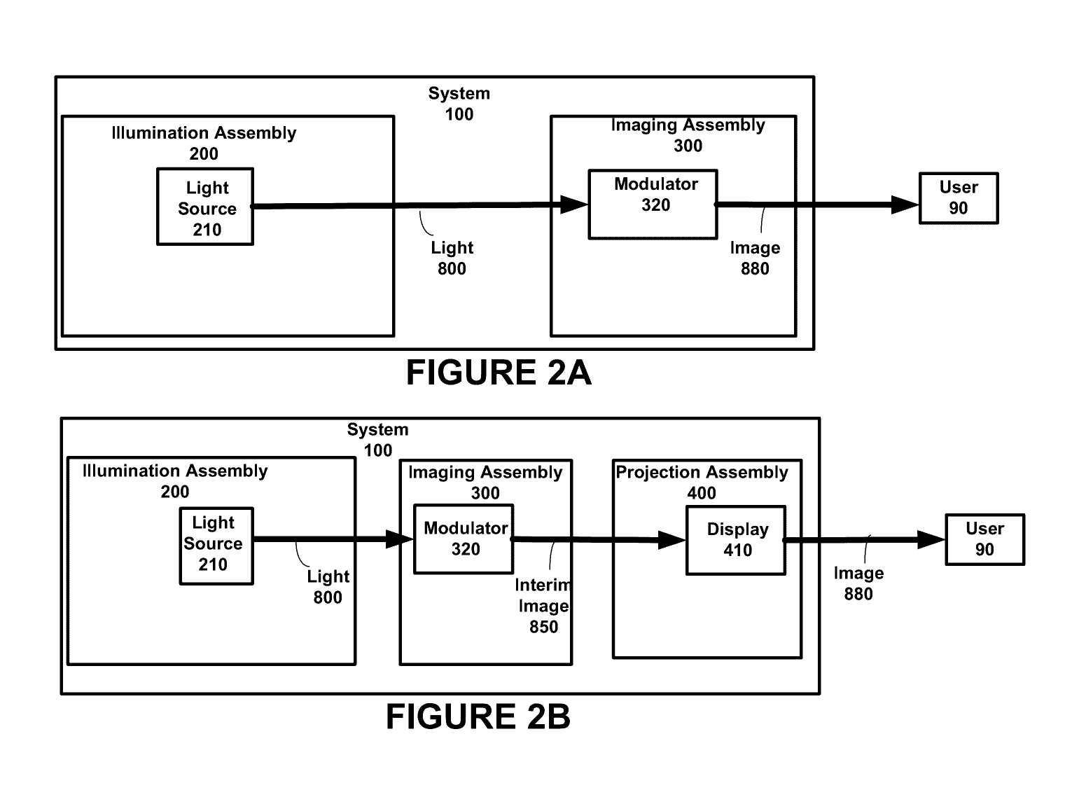

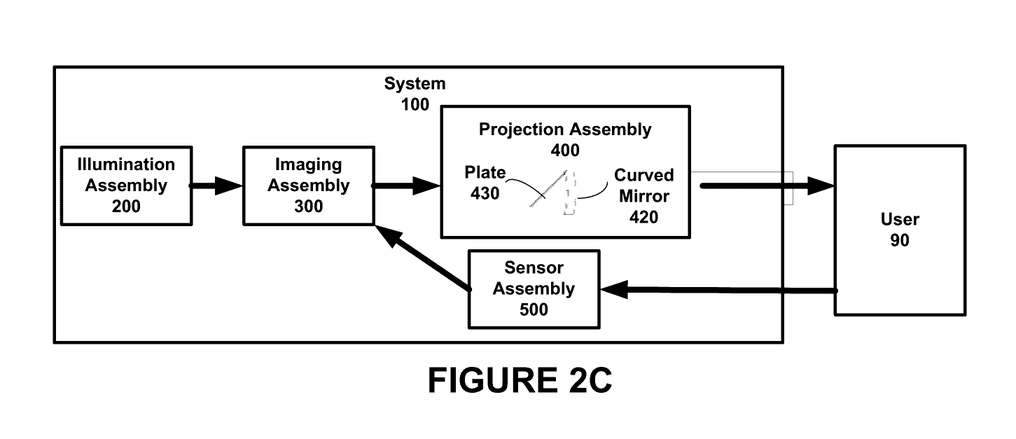

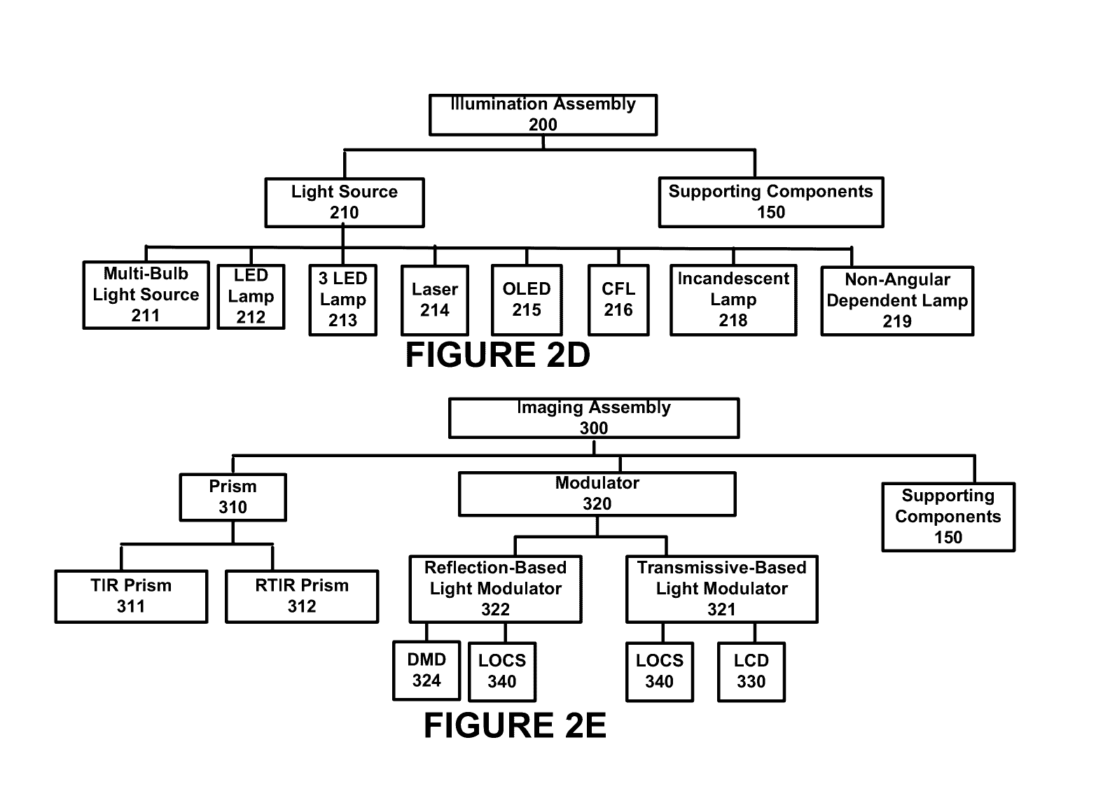

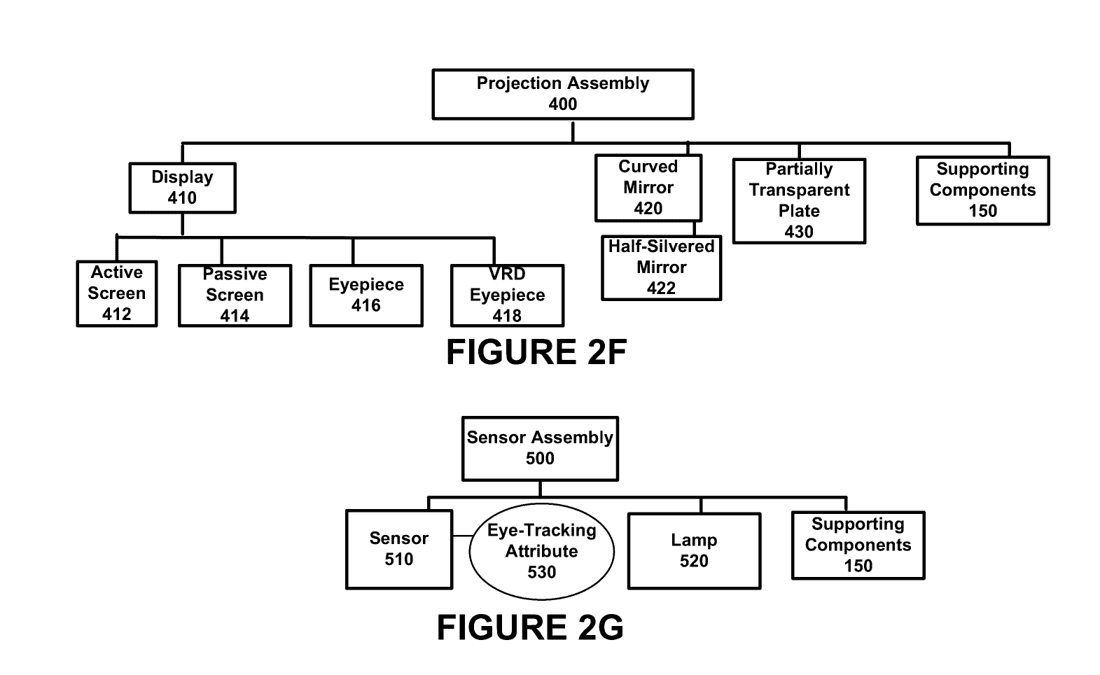

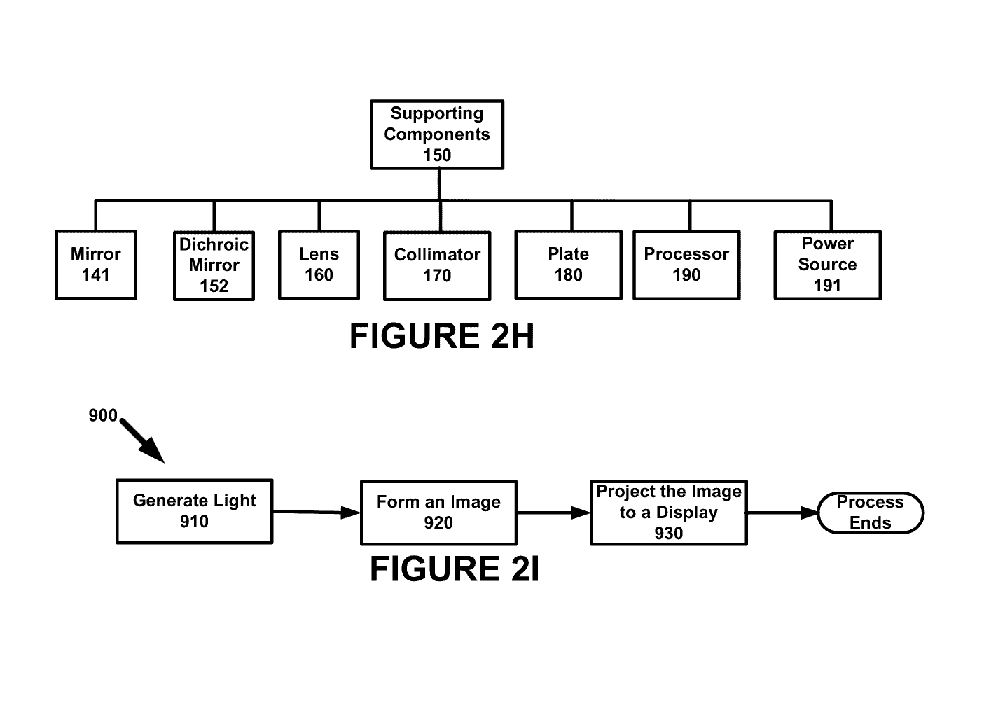

The system 100 can be described in terms of assemblies of components that perform various functions in support of the operation of the system 100. FIG. 2a is a block diagram of a system 100 comprised of an illumination assembly 200 that supplies light 800 to an imaging assembly 300. A modulator 320 of the imaging assembly 300 uses the light 800 from the illumination assembly 200 to create the image 880 that is displayed by the system 100. As illustrated in FIG. 2b, the system 100 can also include a projection assembly 400 that directs the image 880 from the imaging assembly 300 to a location where it can be accessed by one or more users 90. The image 880 generated by the imaging assembly 300 will often be modified in certain ways before it is displayed by the system 100 to users 90, and thus the image generated by the imaging assembly 300 can also be referred to as an interim image 850 or a work-in-process image 850.

A. Illumination Assembly

An illumination assembly 200 performs the function of supplying light 800 to the system 100 so that an image 880 can be displayed. As illustrated in FIGS. 2a and 2b, the illumination assembly 200 can include a light source 210 for generating light 800. The light source 210 is the instrumentation that implements the subframe sequence 854 (along with the modulator 320 to turns individual pixels on or off during the duration of each pulse 810) because it is the light source 210 that supplies light 800 to the system 100.

FIG. 2d is a hierarchy diagram illustrating an example of different components that can be included in the illumination assembly 200. Those components can include but are not limited a wide range of light sources 210, a diffuser assembly 280, and a variety of supporting components 150. Examples of light sources 210 can include but are such as a multi-bulb light source 211, an LED lamp 212, a 3 LED lamp 213, a laser 214, an OLED 215, a CFL 216, an incandescent lamp 218, and a non-angular dependent lamp 219. The light source 210 is where light 800 is generated and moves throughout the rest of the system 100. Thus, each light source 210 is a location 230 for the origination of light 800.

In many instances, it will be desirable to use a 3 LED lamp as a light source, which one LED designated for each primary color of red, green, and blue.

B. Imaging Assembly

An imaging assembly 300 performs the function of creating the image 880 from the light 800 supplied by the illumination assembly 200. As illustrated in FIG. 2a, a modulator 320 can transform the light 800 supplied by the illumination assembly 200 into the image 880 that is displayed by the system 100. As illustrated in FIG. 2b, the image 880 generated by the imaging assembly 300 can sometimes be referred to as an interim image 850 because the image 850 may be focused or otherwise modified to some degree before it is directed to the location where it can be experienced by one or more users 90.

Imaging assemblies 300 can vary significantly based on the type of technology used to create the image. Display technologies such as DLP (digital light processing), LCD (liquid-crystal display), LCOS (liquid crystal on silicon), and other methodologies can involve substantially different components in the imaging assembly 300.

FIG. 2e is a hierarchy diagram illustrating an example of different components that can be utilized in the imaging assembly 300 for the system 100. A prism 310 can be very useful component in directing light to and/or from the modulator 320. DLP applications will typically use an array of TIR prisms 311 or RTIR prisms 312 to direct light to and from a DMD 324.

A modulator 320 (sometimes referred to as a light modulator 320) is the device that modifies or alters the light 800, creating the image 880 that is to be displayed. Modulators 320 can operate using a variety of different attributes of the modulator 320. A reflection-based modulator 322 uses the reflective-attributes of the modulator 320 to fashion an image 880 from the supplied light 800. Examples of reflection-based modulators 322 include but are not limited to the DMD 324 of a DLP display and some LCOS (liquid crystal on silicon) panels 340. A transmissive-based modulator 321 uses the transmissive-attributes of the modulator 320 to fashion an image 880 from the supplied light 800. Examples of transmissive-based modulators 321 include but are not limited to the LCD (liquid crystal display) 330 of an LCD display and some LCOS panels 340. The imaging assembly 300 for an LCOS or LCD system 100 will typically have a combiner cube or some similar device for integrating the different one-color images into a single image 880.

The imaging assembly 300 can also include a wide variety of supporting components 150.

C. Projection Assembly

As illustrated in FIG. 2b, a projection assembly 400 can perform the task of directing the image 880 to its final destination in the system 100 where it can be accessed by users 90. In many instances, the image 880 created by the imaging assembly 300 will be modified in at least some minor ways between the creation of the image 880 by the modulator 320 and the display of the image 880 to the user 90. Thus, the image 880 generated by the modulator 320 of the imaging assembly 400 may only be an interim image 850, not the final version of the image 880 that is actually displayed to the user 90.

FIG. 2f is a hierarchy diagram illustrating an example of different components that can be part of the projection assembly 400. A display 410 is the final destination of the image 880, i.e. the location and form of the image 880 where it can be accessed by users 90. Examples of displays 410 can include an active screen 412, a passive screen 414, an eyepiece 416, and a VRD eyepiece 418.

The projection assembly 400 can also include a variety of supporting components 150 as discussed below.

D. Sensor/Tracking Assembly

FIG. 2c illustrates an example of the system 100 that includes a tracking assembly 500 (which is also referred to as a sensor assembly 500). The sensor assembly 500 can be used to capture information about the user 90, the user's interaction with the image 880, and/or the exterior environment in which the user 90 and system 100 are physically present.

As illustrated in FIG. 2g, the sensor assembly 500 can include a sensor 510, typically a camera such as an infrared camera for capturing an eye-tracking attribute 530 pertaining to eye movements of the viewer 96. A lamp 520 such as an infrared light source to support the functionality of the infrared camera, and a variety of different supporting components 150. In many embodiments of the system 100 that include a tracking assembly 500, the tracking assembly 500 will utilize components of the projection assembly 400 such as the configuration of a curved mirror 420 operating in tandem with a partially transparent plate 430. Such a configuration can be used to capture infrared images of the eye 92 of the viewer 96 while simultaneously delivering images 880 to the eye 92 of the viewer 96.

E. Supporting Components

Light 800 can be a challenging resource to manage. Light 800 moves quickly and cannot be constrained in the same way that most inputs or raw materials can be. FIG. 2f is a hierarchy diagram illustrating an example of some supporting components 150, many of which are conventional optical components. Any display technology application will involve conventional optical components such as mirrors 141 (including dichroic mirrors 152) lenses 160, collimators 170, and plates 180. Similarly, any powered device requires a power source 191 and a device capable of displaying an image 880 is likely to have a processor 190.

F. Process Flow View

The system 100 can be described as the interconnected functionality of an illumination assembly 200, an imaging assembly 300, and a projection assembly 400. The system 100 can also be described in terms of a method 900 that includes an illumination process 910, an imaging process 920, and a projection process 930. The breaking of an image 880 down into subframes 852 can impact both the transmission of light pulses 810 by the illumination assembly 200 and the modulating of that light by the imaging assembly 300 (i.e. pixels must be turned on, of, etc. with each pulse 810).

### III. DIFFERENT DISPLAY TECHNOLOGIES

The system 100 can be implemented with respect to a wide variety of different display technologies, including but not limited to DLP.

A. DLP Embodiments

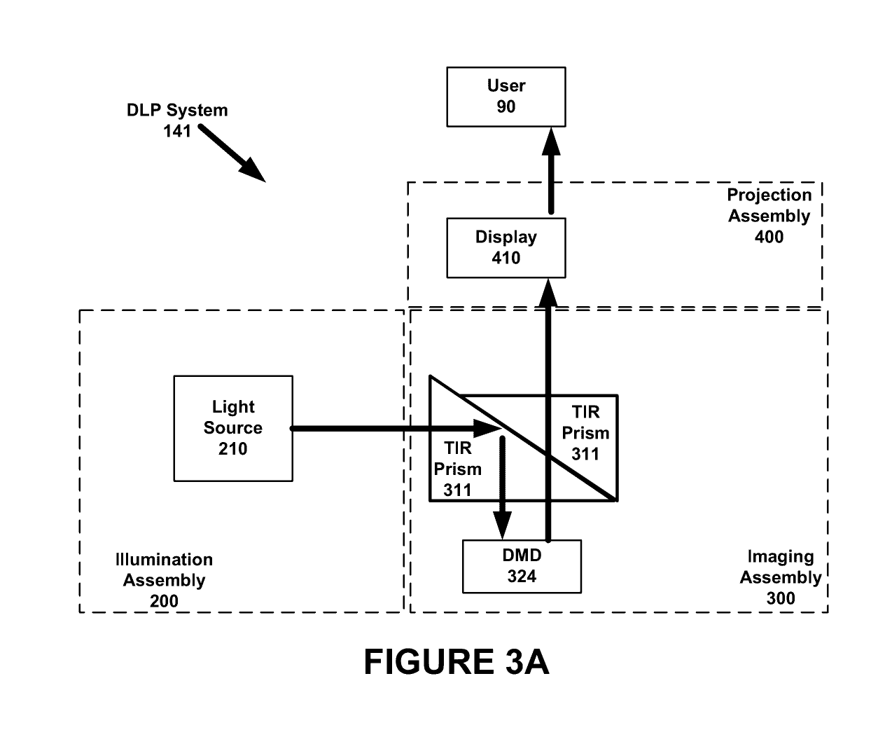

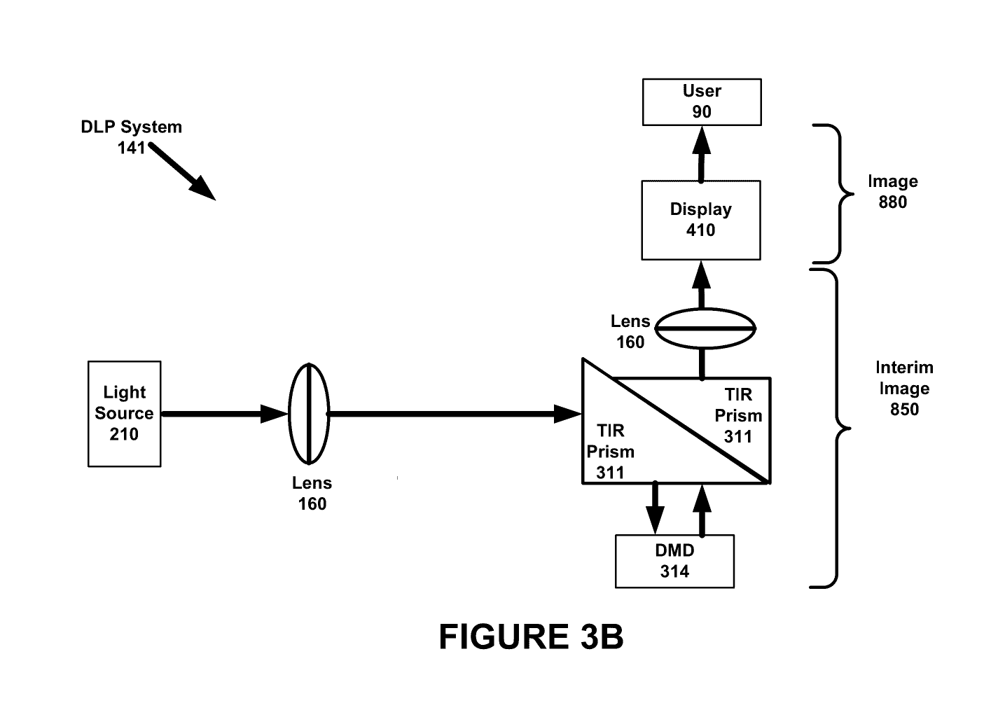

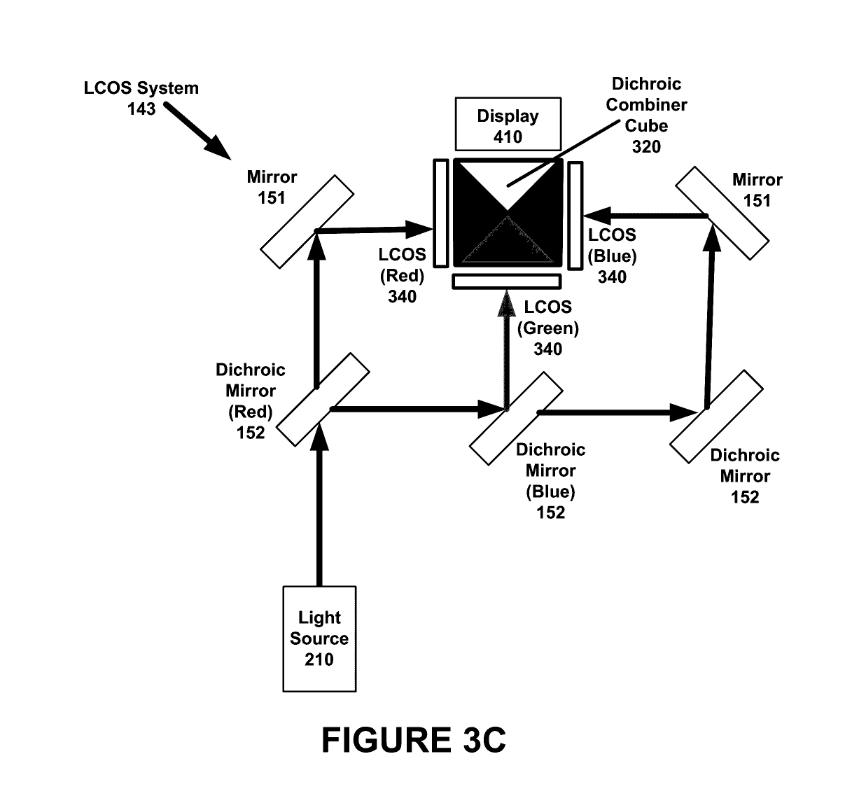

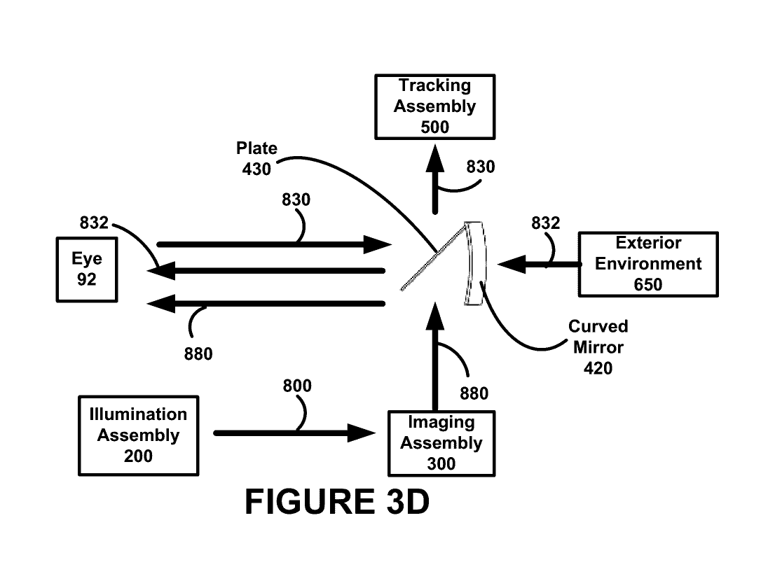

FIG. 3a illustrates an example of a DLP system 141, i.e. an embodiment of the system 100 that utilizes DLP optical elements. DLP systems 141 utilize a DMD 314 (digital micromirror device) comprised of millions of tiny mirrors as the modulator 320. Each micro mirror in the DMD 324 can pertain to a particular pixel in the image 880.

As discussed above, the illumination assembly 200 includes a light source 210 and multiple diffusers 282. The light 800 then passes to the imaging assembly 300. Two TIR prisms 311 direct the light 800 to the DMD 324, the DMD 324 creates an image 880 with that light 800, and the TIR prisms 311 then direct the light 800 embodying the image 880 to the display 410 where it can be enjoyed by one or more users 90.

FIG. 3b is a more detailed example of a DLP system 141. The illumination assembly 200 includes one or more lenses 160, typically a condensing lens 160 and then a shaping lens 160 (not illustrated) is used to direct the light 800 to the array of TIR prisms 311. A lens 160 is positioned before the display 410 to modify/focus image 880 before providing the image 880 to the users 90. FIG. 3b also includes a more specific term for the light 800 at various stages in the process.

B. LCOS Embodiments

FIG. 3c is a diagram illustrating an example of an LCOS system 143. A light source 210 directs light to different dichroic mirrors 152 which direct light to a modulator 320 in the form of a dichroic combiner cube 320. The modulated light is then directed to the display 410 where the image 880 can be seen by one or more viewers 96.

### IV. VRD VISOR EMBODIMENTS

The system 100 can be implemented in a wide variety of different configurations and scales of operation. However, the original inspiration for the conception of using non-identical subframe sequences 854 occurred in the context of a VRD visor system 106 embodied as a VRD visor apparatus 116. A VRD visor apparatus 116 projects the image 880 directly onto the eyes of the user 90. The VRD visor apparatus 116 is a device that can be worn on the head of the user 90. In many embodiments, the VRD visor apparatus 116 can include sound as well as visual capabilities. Such embodiments can include multiple modes of operation, such as visual only, audio only, and audio-visual modes. When used in a non-visual mode, the VRD apparatus 116 can be configured to look like ordinary headphones.

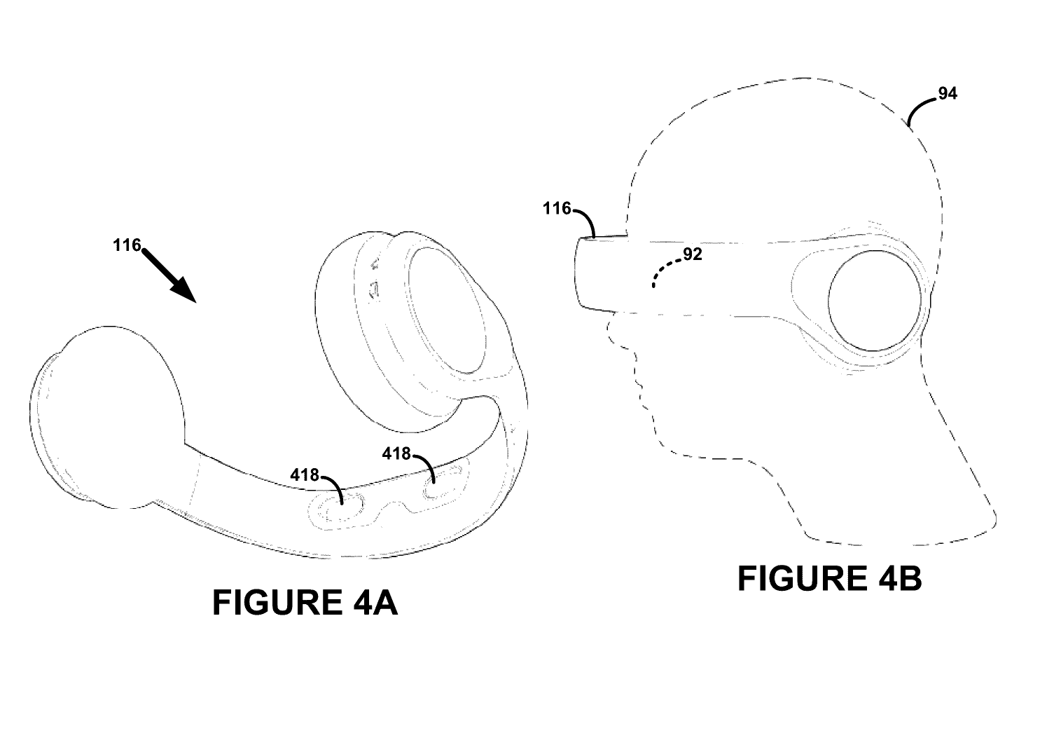

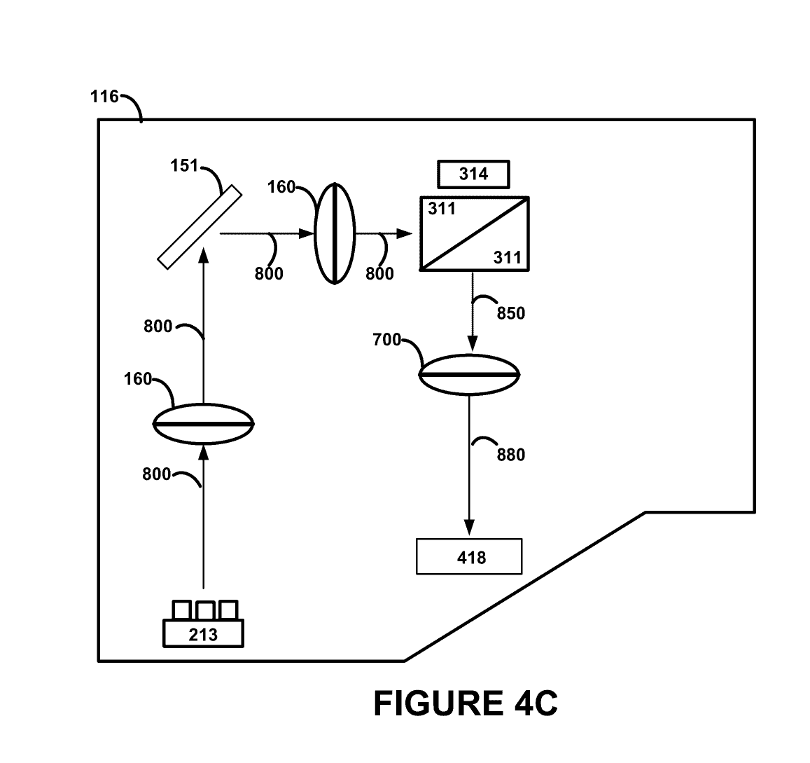

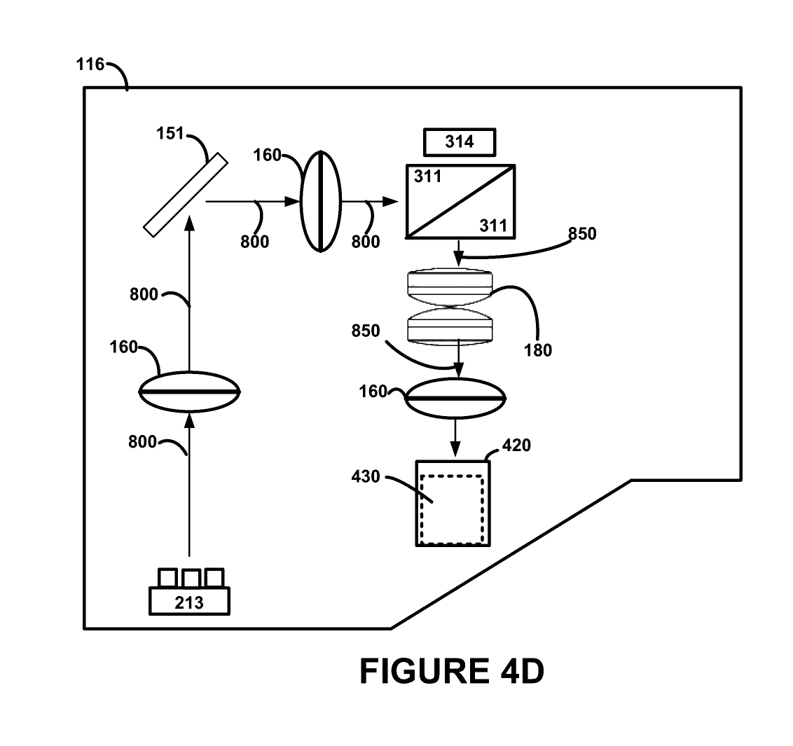

FIG. 4a is a perspective diagram illustrating an example of a VRD visor apparatus 116. Two VRD eyepieces 418 provide for directly projecting the image 880 onto the eyes of the user 90.

FIG. 4b is a side view diagram illustrating an example of a VRD visor apparatus 116 being worn on the head 94 of a user 90. The eyes 92 of the user 90 are blocked by the apparatus 116 itself, with the apparatus 116 in a position to project the image 880 on the eyes 92 of the user 90.

FIG. 4c is a component diagram illustrating an example of a VRD visor apparatus 116 for the left eye 92. A mirror image of FIG. 4c would pertain to the right eye 92.

A 3 LED light source 213 generates the light which passes through a condensing lens 160 that directs the light 800 to a mirror 151 which reflects the light 800 to a shaping lens 160 prior to the entry of the light 800 into an imaging assembly 300 comprised of two TIR prisms 311 and a DMD 314. The interim image 850 from the imaging assembly 300 passes through another lens 160 that focuses the interim image 850 into a final image 880 that is viewable to the user 90 through the eyepiece 416.

### V. ALTERNATIVE EMBODIMENTS

No patent application can expressly disclose in words or in drawings, all of the potential embodiments of an invention. Variations of known equivalents are implicitly included. In accordance with the provisions of the patent statutes, the principles, functions, and modes of operation of the systems 100, methods 900, and apparatuses 110 (collectively the “system” 100) are explained and illustrated in certain preferred embodiments. However, it must be understood that the inventive systems 100 may be practiced otherwise than is specifically explained and illustrated without departing from its spirit or scope.

The description of the system 100 provided above and below should be understood to include all novel and non-obvious alternative combinations of the elements described herein, and claims may be presented in this or a later application to any novel non-obvious combination of these elements. Moreover, the foregoing embodiments are illustrative, and no single feature or element is essential to all possible combinations that may be claimed in this or a later application.

The system 100 represents a substantial improvement over prior art display technologies. Just as there are a wide range of prior art display technologies, the system 100 can be similarly implemented in a wide range of different ways. The innovation of altering the subframe sequence 854 within a particular frame 882 can be implemented at a variety of different scales, utilizing a variety of different display technologies, in both immersive and augmenting contexts, and in both one-way (no sensor feedback from the user 90) and two-way (sensor feedback from the user 90) embodiments.

A. Variations of Scale

Display devices can be implemented in a wide variety of different scales. The monster scoreboard at EverBanks Field (home of the Jacksonville Jaguars) is a display system that is 60 feet high, 362 feet long, and comprised of 35.5 million LED bulbs. The scoreboard is intended to be viewed simultaneously by tens of thousands of people. At the other end of the spectrum, the GLYPH™ visor by Avegant Corporation is a device that is worn on the head of a user and projects visual images directly in the eyes of a single viewer. Between those edges of the continuum are a wide variety of different display systems.

The system 100 displays visual images 808 to users 90 with enhanced light with reduced coherence. The system 100 can be potentially implemented in a wide variety of different scales.

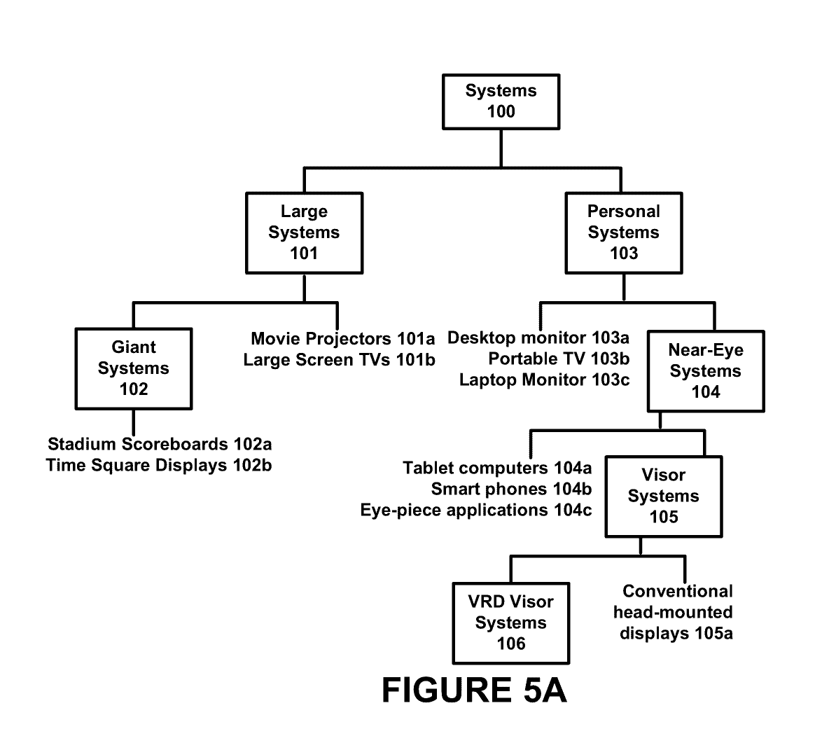

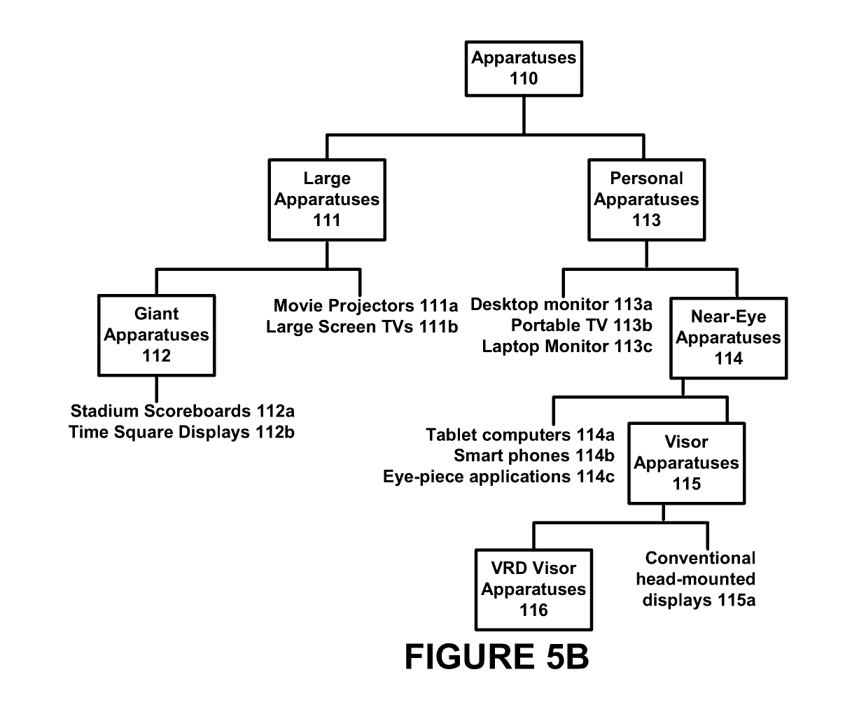

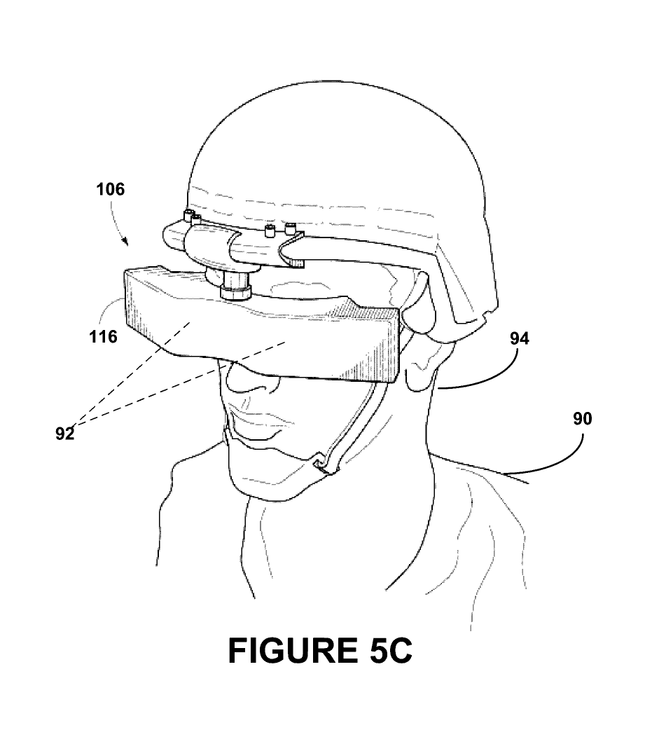

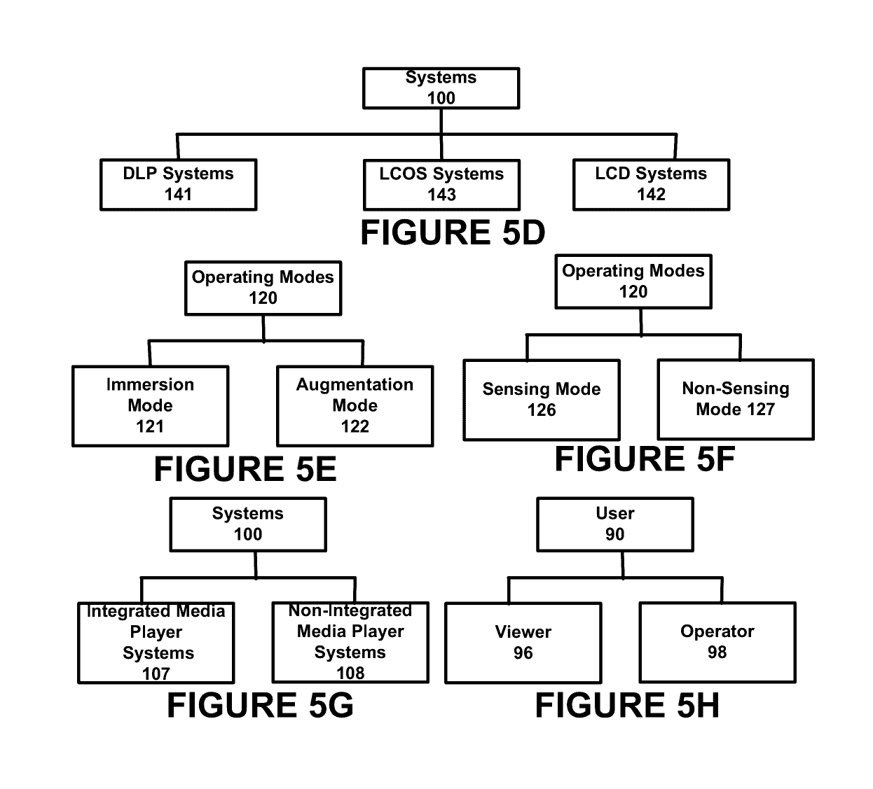

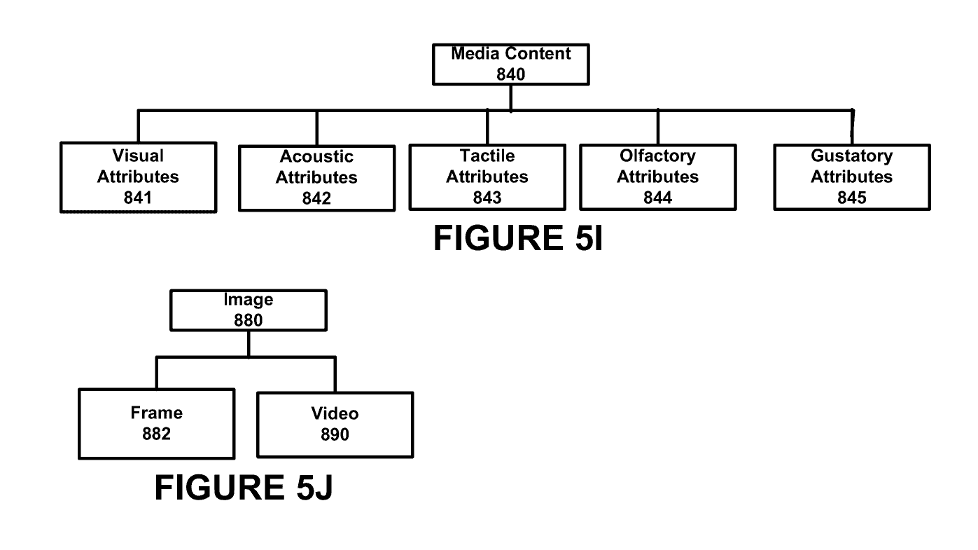

FIG. 5a is a hierarchy diagram illustrating various categories and subcategories pertaining to the scale of implementation for display systems generally, and the system 100 specifically. As illustrated in FIG. 5a, the system 100 can be implemented as a large system 101 or a personal system 103

1. Large Systems

A large system 101 is intended for use by more than one simultaneous user 90. Examples of large systems 101 include movie theater projectors, large screen TVs in a bar, restaurant, or household, and other similar displays. Large systems 101 include a subcategory of giant systems 102, such as stadium scoreboards 102a, the Time Square displays 102b, or other or the large outdoor displays such as billboards off the expressway.

2. Personal Systems

A personal system 103 is an embodiment of the system 100 that is designed to for viewing by a single user 90. Examples of personal systems 103 include desktop monitors 103a, portable TVs 103b, laptop monitors 103c, and other similar devices. The category of personal systems 103 also includes the subcategory of near-eye systems 104.

a. Near-Eye Systems

A near-eye system 104 is a subcategory of personal systems 103 where the eyes of the user 90 are within about 12 inches of the display. Near-eye systems 104 include tablet computers 104a, smart phones 104b, and eye-piece applications 104c such as cameras, microscopes, and other similar devices. The subcategory of near-eye systems 104 includes a subcategory of visor systems 105.

b. Visor Systems

A visor system 105 is a subcategory of near-eye systems 104 where the portion of the system 100 that displays the visual image 200 is actually worn on the head 94 of the user 90. Examples of such systems 105 include virtual reality visors, Google Glass, and other conventional head-mounted displays 105a. The category of visor systems 105 includes the subcategory of VRD visor systems 106.

c. VRD Visor Systems

A VRD visor system 106 is an implementation of a visor system 105 where visual images 200 are projected directly on the eyes of the user. The technology of projecting images directly on the eyes of the viewer is disclosed in a published patent application titled “IMAGE GENERATION SYSTEMS AND IMAGE GENERATING METHODS” (U.S. Ser. No. 13/367,261) that was filed on Feb. 6, 2012, the contents of which are hereby incorporated by reference. It is anticipated that a VRD visor system 106 is particularly well suited for the implementation of the multiple diffuser 140 approach for reducing the coherence of light 210.

3. Integrated Apparatus

Media components tend to become compartmentalized and commoditized over time. It is possible to envision display devices where an illumination assembly 120 is only temporarily connected to a particular imaging assembly 160. However, in most embodiments, the illumination assembly 120 and the imaging assembly 160 of the system 100 will be permanently (at least from the practical standpoint of users 90) into a single integrated apparatus 110. FIG. 5b is a hierarchy diagram illustrating an example of different categories and subcategories of apparatuses 110. FIG. 5b closely mirrors FIG. 5a. The universe of potential apparatuses 110 includes the categories of large apparatuses 111 and personal apparatuses 113. Large apparatuses 111 include the subcategory of giant apparatuses 112. The category of personal apparatuses 113 includes the subcategory of near-eye apparatuses 114 which includes the subcategory of visor apparatuses 115. VRD visor apparatuses 116 comprise a category of visor apparatuses 115 that implement virtual retinal displays, i.e. they project visual images 200 directly into the eyes of the user 90.

FIG. 5c is a diagram illustrating an example of a perspective view of a VRD visor system 106 embodied in the form of an integrated VRD visor apparatus 116 that is worn on the head 94 of the user 90. Dotted lines are used with respect to element 92 because the eyes 92 of the user 90 are blocked by the apparatus 116 itself in the illustration.

B. Different Categories of Display Technology

The prior art includes a variety of different display technologies, including but not limited to DLP (digital light processing), LCD (liquid crystal displays), and LCOS (liquid crystal on silicon). FIG. 5d, which is a hierarchy diagram illustrating different categories of the system 100 based on the underlying display technology in which the system 200 can be implemented. The system 100 is intended for use as a DLP system 141, but could be potentially be used as an LCOS system 143 or even an LCD system 142 although the means of implementation would obviously differ and the reasons for implementation may not exist. The system 100 can also be implemented in other categories and subcategories of display technologies.

C. Immersion Vs. Augmentation

FIG. 5e is a hierarchy diagram illustrating a hierarchy of systems 100 organized into categories based on the distinction between immersion and augmentation. Some embodiments of the system 100 can have a variety of different operating modes 120. An immersion mode 121 has the function of blocking out the outside world so that the user 90 is focused exclusively on what the system 100 displays to the user 90. In contrast, an augmentation mode 122 is intended to display visual images 200 that are superimposed over the physical environment of the user 90. The distinction between immersion and augmentation modes of the system 100 is particularly relevant in the context of near-eye systems 104 and visor systems 105.

Some embodiments of the system 100 can be configured to operate either in immersion mode or augmentation mode, at the discretion of the user 90. While other embodiments of the system 100 may possess only a single operating mode 120.

D. Display Only Vs. Display/Detect/Track/Monitor

Some embodiments of the system 100 will be configured only for a one-way transmission of optical information. Other embodiments can provide for capturing information from the user 90 as visual images 880 and potentially other aspects of a media experience are made accessible to the user 90. Figure ff is a hierarchy diagram that reflects the categories of a one-way system 124 (a non-sensing operating mode 124) and a two-way system 123 (a sensing operating mode 123). A two-way system 123 can include functionality such as retina scanning and monitoring. Users 90 can be identified, the focal point of the eyes 92 of the user 90 can potentially be tracked, and other similar functionality can be provided. In a one-way system 124, there is no sensor or array of sensors capturing information about or from the user 90.

E. Media Players—Integrated Vs. Separate

Display devices are sometimes integrated with a media player. In other instances, a media player is totally separate from the display device. By way of example, a laptop computer can include in a single integrated device, a screen for displaying a movie, speakers for projecting the sound that accompanies the video images, a DVD or BLU-RAY player for playing the source media off a disk. Such a device is also capable of streaming

FIG. 5g is a hierarchy diagram illustrating a variety of different categories of systems 100 based on the whether the system 100 is integrated with a media player or not. An integrated media player system 107 includes the capability of actually playing media content as well as displaying the image 880. A non-integrated media player system 108 must communicate with a media player in order to play media content.

F. Users—Viewers Vs. Operators

FIG. 5h is a hierarchy diagram illustrating an example of different roles that a user 90 can have. A viewer 96 can access the image 880 but is not otherwise able to control the functionality of the system 100. An operator 98 can control the operations of the system 100, but cannot access the image 880. In a movie theater, the viewers 96 are the patrons and the operator 98 is the employee of the theater.

G. Attributes of Media Content

As illustrated in FIG. 5i, media content 840 can include a wide variety of different types of attributes. A system 100 for displaying an image 880 is a system 100 that plays media content 840 with a visual attribute 841. However, many instances of media content 840 will also include an acoustic attribute 842 or even a tactile attribute. Some new technologies exist for the communication of olfactory attributes 844 and it is only a matter of time before the ability to transmit gustatory attributes 845 also become part of a media experience in certain contexts.

As illustrated in FIG. 5j, some images 880 are parts of a larger video 890 context. In other contexts, an image 880 can be stand-alone still frame 882.

### VI. GLOSSARY/DEFINITIONS

Table 1 below sets forth a list of element numbers, names, and descriptions/definitions.

| # | Name | Definition/Description |
|---|---|---|
| 80 | Prior Art | A prior art display apparatus or system. Such a system uses light of a |
| | Display | single intensity as an input for modulating an image 880 that is |
| | | displayed the viewer 96. |
| 90 | User | A user 90 is a viewer 96 and/or operator 98 of the system 100. The |
| | | user 90 is typically a human being. In alternative embodiments, users |
| | | 90 can be different organisms such as dogs or cats, or even automated |
| | | technologies such as expert systems, artificial intelligence |
| | | applications, and other similar “entities”. |
| 92 | Eye | An organ of the user 90 that provides for the sense of sight. The eye |
| | | consists of different portions including but not limited to the sclera, iris, |
| | | cornea, pupil, and retina. Some embodiments of the system 100 |
| | | involve a VRD visor apparatus 116 that can project the desired image |
| | | 880 directly onto the eye 92 of the user 90. |
| 94 | Head | The portion of the body of the user 90 that includes the eye 92. Some |
| | | embodiments of the system 100 can involve a visor apparatus 115 that |
| | | is worn on the head 94 of the user 90. |
| 96 | Viewer | A user 90 of the system 100 who views the image 880 provided by the |
| | | system 100. All viewers 96 are users 90 but not all users 90 are |
| | | viewers 96. The viewer 96 does not necessarily control or operate the |
| | | system 100. The viewer 96 can be a passive beneficiary of the system |
| | | 100, such as a patron at a movie theater who is not responsible for the |
| | | operation of the projector or someone wearing a visor apparatus 115 |
| | | that is controlled by someone else. |
| 98 | Operator | A user 90 of the system 100 who exerts control over the processing of |
| | | the system 100. All operators 98 are users 90 but not all users 90 are |
| | | operators 98. The operator 98 does not necessarily view the images |
| | | 880 displayed by the system 100 because the operator 98 may be |
| | | someone operating the system 100 for the benefit of others who are |
| | | viewers 96. For example, the operator 98 of the system 100 may be |
| | | someone such as a projectionist at a movie theater or the individual |
| | | controlling the system 100. |
| 100 | System | A collective configuration of assemblies, subassemblies, components, |
| | | processes, and/or data that provide a user 90 with the functionality of |
| | | engaging in a media experience such as viewing an image 890. Some |
| | | embodiments of the system 100 can involve a single integrated |
| | | apparatus 110 hosting all components of the system 100 while other |
| | | embodiments of the system 100 can involve different non-integrated |
| | | device configurations. Some embodiments of the system 100 can be |
| | | large systems 102 or even giant system 101 while other embodiments |
| | | of the system 100 can be personal systems 103, such as near-eye |
| | | systems 104, visor systems 105, and VRD visor systems 106. |
| | | Systems 100 can also be referred to as display systems 100. |
| 101 | Giant System | An embodiment of the system 100 intended to be viewed |
| | | simultaneously by a thousand or more people. Examples of giant |
| | | systems 101 include scoreboards at large stadiums, electronic |
| | | billboards such the displays in Time Square in New York City, and |
| | | other similar displays. A giant system 101 is a subcategory of large |
| | | systems 102. |
| 102 | Large System | An embodiment of the system 100 that is intended to display an image |
| | | 880 to multiple users 90 at the same time. A large system 102 is not |
| | | a personal system 103. The media experience provided by a large |
| | | system 102 is intended to be shared by a roomful of viewers 96 using |
| | | the same illumination assembly 200, imaging assembly 300, and |
| | | projection assembly 400. Examples of large systems 102 include but |
| | | are not limited to a projector/screen configuration in a movie theater, |
| | | classroom, or conference room; television sets in sports bar, airport, |
| | | or residence; and scoreboard displays at a stadium. Large systems |
| | | 101 can also be referred to as large display systems 101. |
| 103 | Personal | A category of embodiments of the system 100 where the media |
| | System | experience is personal to an individual viewer 96. Common examples |
| | | of personal media systems include desktop computers (often referred |
| | | to as personal computers), laptop computers, portable televisions, and |
| | | near-eye systems 104. Personal systems 103 can also be referred to |
| | | as personal media systems 103. Near-eye systems 104 are a |
| | | subcategory of personal systems 103. |
| 104 | Near-Eye | A category of personal systems 103 where the media experience is |
| | System | communicated to the viewer 96 at a distance that is less than or equal |
| | | to about 12 inches (30.48 cm) away. Examples of near-eye systems |
| | | 103 include but are not limited to tablet computers, smart phones, |
| | | system 100 involving eyepieces, such as cameras, telescopes, |
| | | microscopes, etc., and visor media systems 105,. Near-eye systems |
| | | 104 can also be referred to as near-eye media systems 104. |
| 105 | Visor System | A category of near-eye media systems 104 where the device or at |
| | | least one component of the device is worn on the head 94 of the viewer |
| | | 96 and the image 880 is displayed in close proximity to the eye 92 of |
| | | the user 90. Visor systems 105 can also be referred to as visor display |
| | | systems 105. |
| 106 | VRD Visor | VRD stands for a virtual retinal display. VRDs can also be referred to |
| | System | as retinal scan displays (“RSD”) and as retinal projectors (“RP”). VRD |
| | | projects the image 880 directly onto the retina of the eye 92 of the |
| | | viewer 96. A VRD Visor System 106 is a visor system 105 that utilizes |
| | | a VRD to display the image 880 on the eyes 92 of the user 90. A VRD |
| | | visor system 106 can also be referred to as a VRD visor display |
| | | system 106. |
| 110 | Apparatus | An at least substantially integrated device that provides the |
| | | functionality of the system 100. The apparatus 110 can include the |
| | | illumination assembly 200, the imaging assembly 300, and the |
| | | projection assembly 400. In some embodiments, the apparatus 110 |
| | | includes the media player 848 that plays the media content 840. In |
| | | other embodiments, the apparatus 110 does not include the media |
| | | player 848 that plays the media content 840. Different configurations |
| | | and connection technologies can provide varying degrees of “plug and |
| | | play” connectivity that can be easily installed and removed by users |
| | | 90. |
| 111 | Giant | An apparatus 110 implementing an embodiment of a giant system |
| | Apparatus | 101. Common examples of a giant apparatus 111 include the |
| | | scoreboards at a professional sports stadium or arena. |
| 112 | Large | An apparatus 110 implementing an embodiment of a large system |
| | Apparatus | 102. Common examples of large apparatuses 111 include movie |
| | | theater projectors and large screen television sets. A large apparatus |
| | | 111 is typically positioned on a floor or some other support structure. |
| | | A large apparatus 111 such as a flat screen TV can also be mounted |
| | | on a wall. |
| 113 | Personal Media | An apparatus 110 implementing an embodiment of a personal system |
| | Apparatus | 103. Many personal apparatuses 112 are highly portable and are |
| | | supported by the user 90. Other embodiments of personal media |
| | | apparatuses 113 are positioned on a desk, table, or similar surface. |
| | | Common examples of personal apparatuses 113 include desktop |
| | | computers, laptop computers, and portable televisions. |
| 114 | Near-Eye | An apparatus 110 implementing an embodiment of a near-eye system |
| | Apparatus | 104. Many near-eye apparatuses 114 are either worn on the head |
| | | (are visor apparatuses 115) or are held in the hand of the user 90. |
| | | Examples of near-eye apparatuses 114 include smart phones, tablet |
| | | computers, camera eye-pieces and displays, microscope eye-pieces |
| | | and displays, gun scopes, and other similar devices. |
| 115 | Visor | An apparatus 110 implementing an embodiment of a visor system 105. |
| | Apparatus | The visor apparatus 115 is worn on the head 94 of the user 90. The |
| | | visor apparatus 115 can also be referred simply as a visor 115. |
| 116 | VRD Visor | An apparatus 110 in a VRD visor system 106. Unlike a visor apparatus |
| | Apparatus | 114, the VRD visor apparatus 115 includes a virtual retinal display that |
| | | projects the visual image 200 directly on the eyes 92 of the user 90. |
| | | A VRD visor apparatus 116 is disclosed in U.S. Pat. No. |
| | | 8,982,014, the contents of which are incorporated by reference in their |
| | | entirety. |
| 120 | Operating | Some embodiments of the system 100 can be implemented in such a |
| | Modes | way as to support distinct manners of operation. In some |
| | | embodiments of the system 100, the user 90 can explicitly or implicitly |
| | | select which operating mode 120 controls. In other embodiments, the |
| | | system 100 can determine the applicable operating mode 120 in |
| | | accordance with the processing rules of the system 100. In still other |
| | | embodiments, the system 100 is implemented in such a manner that |
| | | supports only one operating mode 120 with respect to a potential |
| | | feature. For example, some systems 100 can provide users 90 with a |
| | | choice between an immersion mode 121 and an augmentation mode |
| | | 122, while other embodiments of the system 100 may only support |
| | | one mode 120 or the other. |
| 121 | Immersion | An operating mode 120 of the system 100 in which the outside world |
| | | is at least substantially blocked off visually from the user 90, such that |
| | | the images 880 displayed to the user 90 are not superimposed over |
| | | the actual physical environment of the user 90. In many |
| | | circumstances, the act of watching a movie is intended to be an |
| | | immersive experience. |
| 122 | Augmentation | An operating mode 120 of the system 100 in which the image 880 |
| | | displayed by the system 100 is added to a view of the physical |
| | | environment of the user 90, i.e. the image 880 augments the real |
| | | world. Google Glass is an example of an electronic display that can |
| | | function in an augmentation mode. |
| 126 | Sensing | An operating mode 120 of the system 100 in which the system 100 |
| | | captures information about the user 90 through one or more sensors. |
| | | Examples of different categories of sensing can include eye tracking |
| | | pertaining to the user's interaction with the displayed image 880, |
| | | biometric scanning such as retina scans to determine the identity of |
| | | the user 90, and other types of sensor readings/measurements. |
| 127 | Non-Sensing | An operating mode 120 of the system 100 in which the system 100 |
| | | does not capture information about the user 90 or the user's |
| | | experience with the displayed image 880. |
| 140 | Display | A technology for displaying images. The system 100 can be |
| | Technology | implemented using a wide variety of different display technologies. |
| | | Examples of display technologies 140 include digital light processing |
| | | (DLP), liquid crystal display (LCD), and liquid crystal on silicon |
| | | (LCOS). Each of these different technologies can be implemented in |
| | | a variety of different ways. |
| 141 | DLP System | An embodiment of the system 100 that utilizes digital light processing |
| | | (DLP) to compose an image 880 from light 800. |
| 142 | LCD System | An embodiment of the system 100 that utilizes liquid crystal display |
| | | (LCD) to compose an image 880 from light 800. |
| 143 | LCOS System | An embodiment of the system 100 that utilizes liquid crystal on silicon |
| | | (LCOS) to compose an image 880 from light 800. |
| 150 | Supporting | Regardless of the context and configuration, a system 100 like any |
| | Components | electronic display is a complex combination of components and |
| | | processes. Light 800 moves quickly and continuously through the |
| | | system 100. Various supporting components 150 are used in different |
| | | embodiments of the system 100. A significant percentage of the |
| | | components of the system 100 can fall into the category of supporting |
| | | components 150 and many such components 150 can be collectively |
| | | referred to as “conventional optics”. Supporting components 150 can |
| | | be necessary in any implementation of the system 100 in that light 800 |
| | | is an important resource that must be controlled, constrained, directed, |
| | | and focused to be properly harnessed in the process of transforming |
| | | light 800 into an image 880 that is displayed to the user 90. The text |
| | | and drawings of a patent are not intended to serve as product |
| | | blueprints. One of ordinary skill in the art can devise multiple |
| | | variations of supplementary components 150 that can be used in |
| | | conjunction with the innovative elements listed in the claims, illustrated |
| | | in the drawings, and described in the text. |
| 151 | Mirror | An object that possesses at least a non-trivial magnitude of reflectivity |
| | | with respect to light. Depending on the context, a particular mirror |
| | | could be virtually 100% reflective while in other cases merely 50% |
| | | reflective. Mirrors 151 can be comprised of a wide variety of different |
| | | materials, and configured in a wide variety of shapes and sizes. |
| 152 | Dichroic Mirror | A mirror 151 with significantly different reflection or transmission |
| | | properties at two different wavelengths. |
| 160 | Lens | An object that possesses at least a non-trivial magnitude of |
| | | transmissivity. Depending on the context, a particular lens could be |
| | | virtually 100% transmissive while in other cases merely about 50% |
| | | transmissive. A lens 160 is often used to focus and/or light 800. |
| 170 | Collimator | A device that narrows a beam of light 800. |
| 180 | Plate | An object that possesses a non-trivial magnitude of reflectiveness and |
| | | transmissivity. |
| 190 | Processor | A central processing unit (CPU) that is capable of carrying out the |
| | | instructions of a computer program. The system 100 can use one or |
| | | more processors 190 to communicate with and control the various |
| | | components of the system 100. |
| 191 | Power Source | A source of electricity for the system 100. Examples of power sources |
| | | include various batteries as well as power adaptors that provide for a |
| | | cable to provide power to the system 100. Different embodiments of |
| | | the system 100 can utilize a wide variety of different internal and |
| | | external power sources. 191. Some embodiments can include |
| | | multiple power sources 191. |
| 200 | Illumination | A collection of components used to supply light 800 to the imaging |
| | Assembly | assembly 300. Common example of components in the illumination |
| | | assembly 200 include light sources 210 and diffusers. The illumination |
| | | assembly 200 can also be referred to as an illumination subsystem |
| | | 200. |
| 210 | Light Source | A component that generates light 800. There are a wide variety of |
| | | different light sources 210 that can be utilized by the system 100. |
| 211 | Multi-Prong | A light source 210 that includes more than one illumination element. |
| | Light Source | A 3-colored LED lamp 213 is a common example of a multi-prong light |
| | | source 212. |
| 212 | LED Lamp | A light source 210 comprised of a light emitting diode (LED). |
| 213 | 3 LED Lamp | A light source 210 comprised of three light emitting diodes (LEDs). In |
| | | some embodiments, each of the three LEDs illuminates a different |
| | | color, with the 3 LED lamp eliminating the use of a color wheel. |
| 214 | Laser | A light source 210 comprised of a device that emits light through a |
| | | process of optical amplification based on the stimulated emission of |
| | | electromagnetic radiation. |
| 215 | OLED Lamp | A light source 210 comprised of an organic light emitting diode |
| | | (OLED). |
| 216 | CFL Lamp | A light source 210 comprised of a compact fluorescent bulb. |
| 217 | Incandescent | A light source 210 comprised of a wire filament heated to a high |
| | Lamp | temperature by an electric current passing through it. |
| 218 | Non-Angular | A light source 210 that projects light that is not limited to a specific |
| | Dependent | angle. |
| | Lamp | |
| 219 | Arc Lamp | A light source 210 that produces light by an electric arc. |
| 230 | Light Location | A location of a light source 210, i.e. a point where light originates. |
| | | Configurations of the system 100 that involve the projection of light |
| | | from multiple light locations 230 can enhance the impact of the |
| | | diffusers 282. |
| 300 | Imaging | A collective assembly of components, subassemblies, processes, and |
| | Assembly | light 800 that are used to fashion the image 880 from light 800. In |
| | | many instances, the image 880 initially fashioned by the imaging |
| | | assembly 300 can be modified in certain ways as it is made accessible |
| | | to the user 90. The modulator 320 is the component of the imaging |
| | | assembly 300 that is primarily responsible for fashioning an image 880 |
| | | from the light 800 supplied by the illumination assembly 200. |
| 310 | Prism | A substantially transparent object that often has triangular bases. |
| | | Some display technologies 140 utilize one or more prisms 310 to direct |
| | | light 800 to a modulator 320 and to receive an image 880 or interim |
| | | image 850 from the modulator 320. |
| 311 | TIR Prism | A total internal reflection (TIR) prism 310 used in a DLP 141 to direct |
| | | light to and from a DMD 324. |
| 312 | RTIR Prism | A reverse total internal reflection (RTIR) prism 310 used in a DLP 141 |
| | | to direct light to and from a DMD 324. |
| 320 | Modulator or | A device that regulates, modifies, or adjusts light 800. Modulators 320 |
| | Light Modulator | form an image 880 or interim image 850 from the light 800 supplied by |
| | | the illumination assembly 200. Common categories of modulators 320 |
| | | include transmissive-based light modulators 321 and reflection-based |
| | | light modulators 322. |
| 321 | Transmissive- | A modulator 320 that fashions an image 880 from light 800 utilizing a |
| | Based Light | transmissive property of the modulator 320. LCDs are a common |
| | Modulator | example of a transmissive-based light modulator 321. |
| 322 | Reflection- | A modulator 320 that fashions an image 880 from light 800 utilizing a |
| | Based Light | reflective property of the modulator 320. Common examples of |
| | Modulator | reflection-based light modulators 322 include DMDs 324 and LCOSs |
| | | 340. |
| 324 | DMD | A reflection-based light modulator 322 commonly referred to as a |
| | | digital micro mirror device. A DMD 324 is typically comprised of a |
| | | several thousand microscopic mirrors arranged in an array on a |
| | | processor 190, with the individual microscopic mirrors corresponding |
| | | to the individual pixels in the image 880. |
| 330 | LCD Panel or | A light modulator 320 in an LCD (liquid crystal display). A liquid crystal |
| | LCD | display that uses the light modulating properties of liquid crystals. Each |
| | | pixel of an LCD typically consists of a layer of molecules aligned |
| | | between two transparent electrodes, and two polarizing filters (parallel |
| | | and perpendicular), the axes of transmission of which are (in most of |
| | | the cases) perpendicular to each other. Without the liquid crystal |
| | | between the polarizing filters, light passing through the first filter would |
| | | be blocked by the second (crossed) polarizer. Some LCDs are |
| | | transmissive while other LCDs are transflective. |
| 340 | LCOS Panel or | A light modulator 320 in an LCOS (liquid crystal on silicon) display. A |
| | LCOS | hybrid of a DMD 324 and an LCD 330. Similar to a DMD 324, except |
| | | that the LCOS 326 uses a liquid crystal layer on top of a silicone |
| | | backplane instead of individual mirrors. An LCOS 244 can be |
| | | transmissive or reflective. |
| 350 | Dichroid | A device used in an LCOS or LCD display that combines the different |
| | Combiner | colors of light 800 to formulate an image 880 or interim image 850. |
| | Cube | |
| 400 | Projection | A collection of components used to make the image 880 accessible to |
| | Assembly | the user 90. The projection assembly 400 includes a display 410. The |
| | | projection assembly 400 can also include various supporting |
| | | components 150 that focus the image 880 or otherwise modify the |
| | | interim image 850 transforming it into the image 880 that is displayed |
| | | to one or more users 90. The projection assembly 400 can also be |
| | | referred to as a projection subsystem 400. |
| 410 | Display or | An assembly, subassembly, mechanism, or device by which the image |
| | Screen | 880 is made accessible to the user 90. Examples of displays 410 |
| | | include active screens 412, passive screens 414, eyepieces 416, and |
| | | VRD eyepieces 418. |
| 412 | Active Screen | A display screen 410 powered by electricity that displays the image |
| | | 880. |
| 414 | Passive Screen | A non-powered surface on which the image 880 is projected. A |
| | | conventional movie theater screen is a common example of a passive |
| | | screen 412. |
| 416 | Eyepiece | A display 410 positioned directly in front of the eye 92 of an individual |
| | | user 90. |
| 418 | VRD Eyepiece | An eyepiece 416 that provides for directly projecting the image 880 on |
| | or VRD Display | the eyes 92 of the user 90. A VRD eyepiece 418 can also be referred |
| | | to as a VRD display 418. |
| 420 | Curved Mirror | An at least partially reflective surface that in conjunction with the |
| | | splitting plate 430 projects the image 880 onto the eye 92 of the viewer |
| | | 96. The curved mirror 420 can perform additional functions in |
| | | embodiments of the system 100 that include a sensing mode 126 |
| | | and/or an augmentation mode 122. |
| 430 | Splitting Plate | A partially transparent and partially reflective plate that in conjunction |
| | | with the curved mirror 420 can be used to direct the image 880 to the |
| | | user 90 while simultaneously tracking the eye 92 of the user 90. |
| 500 | Sensor | The sensor assembly 500 can also be referred to as a tracking |
| | Assembly | assembly 500. The sensor assembly 500 is a collection of |
| | | components that can track the eye 92 of the viewer 96 while the viewer |
| | | 96 is viewing an image 880. The tracking assembly 500 can include |
| | | an infrared camera 510, and infrared lamp 520, and variety of |
| | | supporting components 150. The assembly 500 can also include a |
| | | quad photodiode array or CCD. |
| 510 | Sensor | A component that can capture an eye-tracking attribute 530 from the |
| | | eye 92 of the viewer 96. The sensor 510 is typically a camera, such |
| | | as an infrared camera. |
| 520 | Lamp | A light source for the sensor 510. For embodiments of the sensor 510 |
| | | involving a camera 510, a light source is typically very helpful. In some |
| | | embodiments, the lamp 520 is an infrared lamp and the camera is an |
| | | infrared camera. This prevents the viewer 96 from being impacted by |
| | | the operation of the sensor assembly 500. |
| 530 | Eye-Tracking | An attribute pertaining to the movement and/or position of the eye 92 |
| | Attribute | of the viewer 96. Some embodiments of the system 100 can be |
| | | configured to selectively influence the focal point 870 of light 800 in an |
| | | area of the image 880 based on one or more eye-tracking attributes |
| | | 530 measured or captured by the sensor assembly 500. |
| 650 | Exterior | The surroundings of the system 100 or apparatus 110. Some |
| | Environment | embodiments of the system 100 can factor in lighting conditions of the |
| | | exterior environment 650 in supplying light 800 for the display of |
| | | images 880. |
| 800 | Light | Light 800 is the media through which an image is conveyed, and light |
| | | 800 is what enables the sense of sight. Light is electromagnetic |
| | | radiation that is propagated in the form of photons. |
| 810 | Pulse | An emission of light 800. A pulse 810 of light 800 can be defined with |
| | | respect to duration, wavelength, and intensity 820. |
| 820 | Intensity | There are several different potential measures of intensity 820 that are |
| | | well known in the prior art, including but not limited to radian intensity, |
| | | luminous intensity, irradiance, and radiance. The intensity 820 of light |
| | | 800 impacts its perceived brightness to the eye 92 of the viewer 96. |
| 830 | Intensity | The modulator 320 can typically create only so wide a range of |
| | Range | intensities 820 within a single image 880. For example, it is common |
| | | for a particular instance of an image 880 to be limited to pixels 835 |
| | | with a range of 1 to 100. |
| 832 | Expanded | A range of potential intensities 820 that includes more than one |
| | Intensity | intensity range 830 from more than one pulse 810 to create a single |
| | Range | image 880. |
| 835 | Pixel | An area of the image 880 that is sufficiently small such that it cannot |
| | | be subdivided further. |
| 836 | Intensity Value | A numerical value representing the magnitude of intensity 820 with |
| | | respect to an individual pixel 835. The intensity value 836 is |
| | | constrained by the applicable range 832. |
| 840 | Media Content | The image 880 displayed to the user 90 by the system 100 can in |
| | | many instances, be but part of a broader media experience. A unit of |
| | | media content 840 will typically include visual attributes 841 and |
| | | acoustic attributes 842. Tactile attributes 843 are not uncommon in |
| | | certain contexts. It is anticipated that the olfactory attributes 844 and |
| | | gustatory attributes 845 may be added to media content 840 in the |
| | | future. |
| 841 | Visual | Attributes pertaining to the sense of sight. The core function of the |
| | Attributes | system 100 is to enable users 90 to experience visual content such as |
| | | images 880 or video 890. In many contexts, such visual content will |
| | | be accompanied by other types of content, most commonly sound or |
| | | touch. In some instances, smell or taste content may also be included |
| | | as part of the media content 840. |
| 842 | Acoustic | Attributes pertaining to the sense of sound. The core function of the |
| | Attributes | system 100 is to enable users 90 to experience visual content such as |
| | | images 880 or video 890. However, such media content 840 will also |
| | | involve other types of senses, such as the sense of sound. The system |
| | | 100 and apparatuses 110 embodying the system 100 can include the |
| | | ability to enable users 90 to experience tactile attributes 843 included |
| | | with other types of media content 840. |
| 843 | Tactile | Attributes pertaining to the sense of touch. Vibrations are a common |
| | Attributes | example of media content 840 that is not in the form of sight or sound. |
| | | The system 100 and apparatuses 110 embodying the system 100 can |
| | | include the ability to enable users 90 to experience tactile attributes |
| | | 843 included with other types of media content 840. |
| 844 | Olfactory | Attributes pertaining to the sense of smell. It is anticipated that future |
| | Attributes | versions of media content 840 may include some capacity to engage |
| | | users 90 with respect to their sense of smell. Such a capacity can be |
| | | utilized in conjunction with the system 100, and potentially integrated |
| | | with the system 100. The iPhone app called oSnap is a current |
| | | example of gustatory attributes 845 being transmitted electronically. |
| 845 | Gustatory | Attributes pertaining to the sense of taste. It is anticipated that future |
| | Attributes | versions of media content 840 may include some capacity to engage |
| | | users 90 with respect to their sense of taste. Such a capacity can be |
| | | utilized in conjunction with the system 100, and potentially integrated |
| | | with the system 100. |
| 848 | Media Player | The system 100 for displaying the image 880 to one or more users 90 |
| | | may itself belong to a broader configuration of applications and |
| | | systems. A media player 848 is device or configuration of devices that |
| | | provide the playing of media content 840 for users. Examples of |
| | | media players 848 include disc players such as DVD players and BLU- |
| | | RAY players, cable boxes, tablet computers, smart phones, desktop |
| | | computers, laptop computers, television sets, and other similar |
| | | devices. Some embodiments of the system 100 can include some or |
| | | all of the aspects of a media player 848 while other embodiments of |
| | | the system 100 will require that the system 100 be connected to a |
| | | media player 848. For example, in some embodiments, users 90 may |
| | | connect a VRD apparatus 116 to a BLU-RAY player in order to access |
| | | the media content 840 on a BLU-RAY disc. In other embodiments, |
| | | the VRD apparatus 116 may include stored media content 840 in the |
| | | form a disc or computer memory component. Non-integrated versions |
| | | of the system 100 can involve media players 848 connected to the |
| | | system 100 through wired and/or wireless means. |
| 850 | Interim Image | The image 880 displayed to user 90 is created by the modulation of |
| | | light 800 generated by one or light sources 210 in the illumination |
| | | assembly 200. The image 880 will typically be modified in certain |
| | | ways before it is made accessible to the user 90. Such earlier versions |
| | | of the image 880 can be referred to as an interim image 850. |
| 852 | Subframe | A portion of the image 880. The image 880 can be comprised of |
| | | subframes 852 that correlate at least in part to intensity regions 860 |
| | | within the image 880. |
| 854 | Subframe | The order in which subframes 852 are displayed within the frame. The |
| | Sequence | subframe sequence 854 includes order, duration, and intensity of |
| | | pulses 810. The system 100 can determine subframe sequences 854 |
| | | for reasons of intensity. Different pulses 810 within the same frame |
| | | can involve the same color. |
| 860 | Intensity | A subset of an image 880 or interim image 850 that is comprised of |
| | Region | light 800 originating from the same pulse 810 and possessing the |
| | | same intensity 820. |
| 880 | Image | A visual representation such as a picture or graphic. The system 100 |
| | | performs the function of displaying images 880 to one or more users |
| | | 90. During the processing performed by the system 100, light 800 is |
| | | modulated into an interim image 850, and subsequent processing by |
| | | the system 100 can modify that interim image 850 in various ways. At |
| | | the end of the process, with all of the modifications to the interim image |
| | | 850 being complete the then final version of the interim image 850 is |
| | | no longer a work in process, but an image 880 that is displayed to the |
| | | user 90. In the context of a video 890, each image 880 can be referred |
| | | to as a frame 882. |
| 881 | Stereoscopic | A dual set of two dimensional images 880 that collectively function as |
| | Image | a three dimensional image. |
| 882 | Frame | An image 880 that is a part of a video 890. |
| 890 | Video | In some instances, the image 880 displayed to the user 90 is part of a |
| | | sequence of images 880 can be referred to collectively as a video 890. |
| | | Video 890 is comprised of a sequence of static images 880 |
| | | representing snapshots displayed in rapid succession to each other. |
| | | Persistence of vision in the user 90 can be relied upon to create an |
| | | illusion of continuity, allowing a sequence of still images 880 to give |
| | | the impression of motion. The entertainment industry currently relies |
| | | primarily on frame rates between 24 FPS and 30 FPS, but the system |
| | | 100 can be implemented at faster as well as slower frame rates. |
| 891 | Stereoscopic | A video 890 comprised of stereoscopic images 881. |
| | Video | |
| 900 | Method | A process for displaying an image 880 to a user 90. |
| 910 | Illumination | A process for generating light 800 for use by the system 100. The |
| | Method | illumination method 910 is a process performed by the illumination |
| | | assembly 200. |
| 920 | Imaging | A process for generating an interim image 850 from the light 800 |
| | Method | supplied by the illumination assembly 200. The imaging method 920 |
| | | can also involve making subsequent modifications to the interim image |
| | | 850. |
| 930 | Display Method | A process for making the image 880 available to users 90 using the |
| | | interim image 850 resulting from the imaging method 920. The display |
| | | method 930 can also include making modifications to the interim |
| | | image 850. |

1. A system (100) for displaying an image (880) to a user (90), said system (100) comprising:
an illumination assembly (200) that provides for supplying a plurality of light (800) to a modulator (320), said plurality of light (800) including a plurality of light pulses (810) of a plurality of intensities (820), said plurality of light pulses (810) including a first light pulse (810) of a first intensity (820) and a second light pulse (810) of a second intensity (820); and
an imaging assembly (300) that includes said modulator (320) for creating a plurality of subframes (852) from said plurality of light pulses (810), wherein said first subframe (852) is created with said first light pulse (810) of said first intensity (820) and wherein said second subframe (852) is created with said second light pulse (810) of said second intensity (820);
wherein said image (880) perceived by user (90) through the display of said subframes (852), and wherein said first intensity (820) is different than said second intensity (820); and
wherein said first pulse (810) is the same color as said second pulse (810).

2. The system (100) of claim 1, wherein said illumination assembly (200) includes a plurality of light sources (210), said plurality of light sources (210) including a first light source (210) that provides for said first light pulse (810) and a second light source (210) that provides for said second light (810).

3. The system (100) of claim 1, wherein said first light pulse (810) is generated before said second light pulse (810), and wherein said second intensity (820) is less than or equal to about 20% of said first intensity (820).

4. The system (100) of claim 1, said system (100) further comprising a sensor assembly (500), said sensor assembly (500) providing for the capture of an ambient light attribute (540), wherein said ambient light attribute (540) selectively influences at least one of said intensities (820).

5. The system (100) of claim 1, said system (100) further comprising a sensor assembly (500), said sensor assembly (500) providing for the capture of an eye tracking attribute (530), wherein said eye tracking attribute (530) selectively influences at least one of said intensities.

6. The system (100) of claim 1, said system (100) further comprising a sensor assembly (500), said sensor assembly (500) providing for the capture of an eye tracking attribute (530) and an ambient light attribute (540), wherein said eye tracking attribute (530) and said ambient light attribute (540) selectively influence at least one said light pulse (810) from said illumination assembly (200).

7. The system (100) of claim 1, wherein plurality of intensities (820) include at least three different said intensities (820) and wherein said second intensity (820) is no greater than about 15% of said first intensity (820), and wherein said third intensity (820) is no greater than about 15% of said second intensity (820).

8. The system (100) of claim 1, wherein said system (100) projects said image (880) in an augmentation mode (122).

9. The system (100) of claim 1, wherein said system (100) further includes a projection assembly (400), said projection assembly (400) including a curved mirror (420) and a splitter plate (430), wherein said projection assembly (400) provides for delivering said image (880) to the user (90).

10. The system (100) of claim 9, wherein said splitter plate (430) is at least about 40% transparent, said system (100) further comprising a sensor assembly (500) that includes said curved mirror (420) and said splitter plate (430) to capture an eye tracking attribute (530), wherein said image (880) is selectively influenced by said eye tracking attribute (530).

11. The system (100) of claim 1, wherein said system (100) is a personal system (103).

12. The system (100) of claim 1, wherein said system (100) is a VRD visor apparatus (115).

13. The system (100) of claim 1, wherein said modulator (320) is a reflection-based light modulator (322).

14. The system (100) of claim 1, wherein said image (880) is a frame (882) in a 3D video (891).

15. The system (100) of claim 1, wherein said system (100) includes a plurality of operating modes (120), said plurality of operating modes (120) includes an immersion mode (121), an augmentation mode (122), a tracking mode (123), and a non-tracking mode (124).

16. The system (100) of claim 1, wherein said plurality of light pulses (810) includes a first light pulse (810), a second light pulse (810), and a third light pulse (810), wherein said plurality of intensities (820) includes a first intensity (820) possessed by said first light pulse (810), a second intensity (820) possessed by said second light pulse (810), a and a third intensity (820) possessed by said third light pulse (810), wherein said plurality of subframes (852) includes a first subframe (852) from said first pulse (810), a second subframe (852) from said second pulse (810), and a third subframe (852) from said third pulse (810).

17. A system (100) for displaying an image (880) to a user (90), said system (100) comprising:
an illumination assembly (200) that provides for supplying a plurality of light (800) to a modulator (320), said plurality of light (800) including a plurality of light pulses (810) of a plurality of intensities (820), said plurality of light pulses (810) including a first light pulse (810) of a first intensity (820) and a second light pulse (810) of a second intensity (820), wherein said first intensity (820) is at least about 8 times more intense than said second intensity (820);
an imaging assembly (300) that includes said modulator (320) for creating a plurality of subframes (852) from said plurality of light pulses (810), wherein said first subframe (852) is created with said first light pulse (810) of said first intensity (820) and wherein said second subframe (852) is created with said second light pulse (810) of said second intensity (820), wherein said plurality of subframes (852) comprise an interim image (850) that is modified by said projection assembly (400) prior to the delivery of said light (800) to the user (90); and
a projection assembly (400) that includes a curved mirror (420) and a splitter plate (430) that provide displaying said image (880) to the user (90) from said interim image (850) provided by said imaging assembly (300).

18. The system (100) of claim 17, wherein illumination assembly (200) includes a plurality of light sources (210), said system (100) further comprising a sensor assembly (500) that provides for a capturing at least one of: (a) an eye-tracking attribute (530) and (b) an ambient light attribute (540) that provide for selectively influencing at least one said intensity (820) of at least one said pulse (810).

19. The system (100) of claim 17, wherein said system (100) is a VRD visor apparatus (116) that includes an augmentation mode (122).

20. A method (900) for displaying an image (880) to a user (90), said method (900) comprising:
supplying (910) light (800) for the image (880) in the form of a plurality of light pulses (810) of a plurality of intensities (820), wherein not all light pulses (810) have identical intensities (820);
modulating (920) the plurality of pulses (810) into a plurality of subframes (852) comprising the image (880).
